(19) United States
(12) Patent Application Publication
(10) Pub. No.: US 2026/0278395 A1
(43) Pub. Date: Sep. 17, 2026

(54) MODEL-BASED PREDICTION

(71) Applicant: Tencent Technology (Shenzhen) Company Limited, Shenzhen (CN)

(72) Inventor: Ying DU, Shenzhen (CN)

(73) Assignee: Tencent Technology (Shenzhen) Company Limited, Shenzhen (CN)

(21) Appl. No.: 19/678,241

(22) Filed: May 15, 2026

Related U.S. Application Data
(63) Continuation of application No. PCT/CN2025/082620, filed on Mar. 14, 2025.

(30) Foreign Application Priority Data
Apr. 15, 2024 (CN) 202410451912.4

(51) Int. Cl. G06N 3/096

(52) U.S. Cl. CPC G06N 3/096

(57) ABSTRACT

In a model-based prediction method, an initial prediction result of a first task is generated through a first upper-layer network structure based on a lower-layer output of a lower-layer network structure. In the method, global knowledge information is generated based on an output of the first upper-layer network structure and an output of each of one or more other upper-layer network structures. In the method, an updated prediction result of the first task is generated based on a network layer output of the first upper-layer network structure and the global knowledge information. In the method, a difference prompt is generated based on a difference between the initial prediction result and the updated prediction result. In the method, a refined prediction result of the first task is generated through the first upper-layer network structure based on the difference prompt and the initial prediction result.

### RELATED APPLICATIONS

The present application is a continuation of International Application No. PCT/CN2025/082620, filed on March 14, 2025, which claims priority to Chinese Patent Application No. 202410451912.4, filed on April 15, 2024, and entitled "MODEL PREDICTION METHOD AND APPARATUS, DEVICE, AND MEDIUM." The entire disclosures of the prior applications are hereby incorporated by reference.

### FIELD OF THE TECHNOLOGY

This disclosure relates to the field of artificial intelligence (AI), including a model-based prediction method and apparatus, a device, and a medium.

### BACKGROUND

Multi-task learning (MTL) refers to learning a plurality of related prediction tasks simultaneously by using a multi-task model. For example, different prediction tasks that may be performed based on a multi-task model may include a click-through rate, a reading duration, and interaction (e.g., commenting, forwarding, and liking). In MTL in a recommendation system, the plurality of prediction tasks may reflect satisfaction of a user on recommended content from different hierarchical perspectives.

In one or more applications, a multi-task model structure includes a lower-layer network structure located at a logical lower layer and a plurality of parallel upper-layer network structures located at a logical upper layer. A network branch of each prediction task includes the shared lower-layer network structure and a respective upper-layer network structure. The plurality of prediction tasks shares the same lower-layer network structure, and the upper-layer network structures of the prediction tasks may be independent of each other.

However, in some applications, there is still space to improve accuracy of a prediction result of each prediction task based on a multi-task model.

### SUMMARY

This disclosure includes a model-based prediction method and apparatus, a device, and a medium.

According to an aspect of this disclosure, a model-based prediction method is provided. In the method, an initial prediction result of a first task is generated through a first upper-layer network structure of a plurality of upper-layer network structures of a multi-task model based on a lower-layer output of a lower-layer network structure of the multi-task model. In the method, global knowledge information is generated based on an output of the first upper-layer network structure and an output of each of one or more other upper-layer network structures of the plurality of upper-layer network structures. In the method, an updated prediction result of the first task is generated based on a network layer output of the first upper-layer network structure and the global knowledge information. In the method, a difference prompt is generated based on a difference between the initial prediction result of the first task and the updated prediction result of the first task. In the method, a refined prediction result of the first task is generated through the first upper-layer network structure based on the difference prompt and the initial prediction result of the first task.

According to another aspect of this disclosure, a model-based prediction apparatus is provided. The apparatus includes processing circuitry configured to generate an initial prediction result of a first task through a first upper-layer network structure of a plurality of upper-layer network structures of a multi-task model based on a lower-layer output of a lower-layer network structure of the multi-task model. The processing circuitry is configured to generate global knowledge information based on an output of the first upper-layer network structure and an output of each of one or more other upper-layer network structures of the plurality of upper-layer network structures. The processing circuitry is configured to generate an updated prediction result of the first task based on a network layer output of the first upper-layer network structure and the global knowledge information. The processing circuitry is configured to generate a difference prompt based on a difference between the initial prediction result of the first task and the updated prediction result of the first task. The processing circuitry is configured to generate a refined prediction result of the first task through the first upper-layer network structure based on the difference prompt and the initial prediction result of the first task.

According to another aspect of this disclosure, a non-transitory computer-readable storage medium is provided. The non-transitory computer-readable storage medium stores instructions, which when executed by a processor, cause the processor to perform a model-based prediction method. In the method, an initial prediction result of a first task is generated through a first upper-layer network structure of a plurality of upper-layer network structures of a multi-task model based on a lower-layer output of a lower-layer network structure of the multi-task model. In the method, global knowledge information is generated based on an output of the first upper-layer network structure and an output of each of one or more other upper-layer network structures of the plurality of upper-layer network structures. In the method, an updated prediction result of the first task is generated based on a network layer output of the first upper-layer network structure and the global knowledge information. In the method, a difference prompt is generated based on a difference between the initial prediction result of the first task and the updated prediction result of the first task. In the method, a refined prediction result of the first task is generated through the first upper-layer network structure based on the difference prompt and the initial prediction result of the first task.

According to an aspect of this disclosure, a model-based prediction method is provided. The method is performed by a computer device. The method includes: predicting a first task by using a first upper-layer network structure among a plurality of upper-layer network structures of a multi-task model to obtain an initial prediction result of the first task; obtaining global knowledge information of the multi-task model, the global knowledge information representing comprehensive prediction information jointly reflected by at least two tasks, and obtaining an updated prediction result of the first task through prediction based on a network layer output of the first upper-layer network structure and the global knowledge information; obtaining a difference prompt based on a difference between the initial prediction result of the first task and the updated prediction result of the first task; and guiding, based on the difference prompt, the first upper-layer network structure to correct the initial prediction result of the first task, to obtain a refined prediction result of the first task.

According to another aspect of this disclosure, a model-based prediction apparatus is provided. The apparatus includes: a prediction module, configured to predict a first task by using a first upper-layer network structure among a plurality of upper-layer network structures of a multi-task model to obtain an initial prediction result of the first task; an obtaining module, configured to obtain global knowledge information of the multi-task model, the global knowledge information representing comprehensive prediction information jointly reflected by at least two tasks, and the prediction module being further configured to obtain an updated prediction result of the first task through prediction based on a network layer output of the first upper-layer network structure and the global knowledge information; and a prompt construction module, configured to obtain a difference prompt based on a difference between the initial prediction result of the first task and the updated prediction result of the first task, the prediction module being further configured to guide, based on the difference prompt, the first upper-layer network structure to correct the initial prediction result of the first task, to obtain a refined prediction result of the first task.

According to an aspect of this disclosure, a computer device is provided. The computer device includes processing circuitry (e.g., a processor) and a memory, the memory may include a non-transitory computer-readable storage medium having a computer program (e.g., instructions) stored therein, and the computer program being loaded and executed by the processor to implement one or more model-based prediction methods described in this disclosure.

According to another aspect of this disclosure, a non-transitory computer-readable storage medium is provided. The non-transitory computer-readable storage medium has a computer program stored therein, the computer program being loaded and executed by processing circuitry (e.g., a processor) to implement one or more model-based prediction methods described in this disclosure.

According to another aspect of this disclosure, a computer program product or a computer program is provided. The computer program product or the computer program includes computer instructions. The computer instructions are stored in a non-transitory computer-readable storage medium. Processing circuitry (e.g., a processor) of the computer device reads the computer instructions from the non-transitory computer-readable storage medium. The processor executes the computer instructions, to cause the computer device to perform one or more model-based prediction methods described in this disclosure.

Details of one or more embodiments of this disclosure are provided in accompanying drawings and description below.

### BRIEF DESCRIPTION OF THE DRAWINGS

To describe technical solutions in aspects of this disclosure, the following briefly describes the accompanying drawings for describing the aspects. The accompanying drawings in the following descriptions show some aspects of this disclosure, and a person of ordinary skill in the art may still derive other drawings from these disclosed accompanying drawings.

FIG. 1 is a schematic diagram of a multi-task model.

FIGS. 2A and 2B are schematic diagrams of a model-based prediction method according to an aspect of this disclosure.

FIG. 3 is a schematic diagram of a multi-task system according to an aspect of this disclosure.

FIG. 4 is a flowchart of a model-based prediction method according to an aspect of this disclosure.

FIG. 5 is a flowchart of a model-based prediction method according to another aspect of this disclosure.

FIG. 6 is a flowchart of a model-based prediction method according to another aspect of this disclosure.

FIG. 7 is a schematic diagram of a global knowledge distillation network according to an aspect of this disclosure.

FIG. 8 is a flowchart of a method for constructing a task consistency indicator according to an aspect of this disclosure.

FIG. 9 is a flowchart of a prediction method applied to a multi-task model in a recommendation system according to an aspect of this disclosure.

FIG. 10 is a flowchart of a prediction method applied to a multi-task model in an advertisement system according to an aspect of this disclosure.

FIG. 11 is a flowchart of a prediction method applied to a multi-task model in a search system according to an aspect of this disclosure.

FIG. 12 is a structural block diagram of a model-based prediction apparatus according to an aspect of this disclosure.

FIG. 13 is a structural block diagram of a computer device according to an aspect of this disclosure.

FIG. 14 is a structural block diagram of a computer device according to another aspect of this disclosure.

### DETAILED DESCRIPTION

Technical solutions in aspects of this disclosure are described in the following with reference to the accompanying drawings in this disclosure. The described aspects are some of the aspects of this disclosure. Other aspects obtained by a person of ordinary skill in the art based on this disclosure also fall within the scope of this disclosure.

Descriptions of terms in this disclosure are provided as examples only and are not intended to limit the scope of the disclosure. First, some terms used in this disclosure are briefly introduced.

AI may correspond to a theory, a method, a technology, and an application system that use a digital computer or a machine controlled by the digital computer to simulate, extend, and expand human intelligence, perceive an environment, obtain knowledge, and use knowledge to obtain an optimal result. In other words, AI may correspond to a comprehensive technology in computer science and may attempt to understand the essence of intelligence and produce a new intelligent machine that can react in a mode similar to human intelligence. AI may correspond to study of design principles and implementation methods of various intelligent machines, to enable the machines to have functions of perception, inference, and decision-making.

The AI technology may correspond to a comprehensive discipline, and involves a wide range of fields including both the hardware-level technology and the software-level technology. Basic AI technologies may include a sensor, a dedicated AI chip, cloud computing, distributed storage, a big data processing technology, a pre-training model technology, an operating/interaction system, electromechanical integration, and the like. The pre-training model may also be referred to as a large model or a basic model, and may be widely applied to downstream tasks in various large directions of AI after fine adjustment. AI software technologies may include several major directions such as a computer vision technology, a speech processing technology, a nature language processing technology, and machine learning/deep learning.

Large model may also be referred to as a large-scale AI model, which may be an AI model with a large number of parameters and a complex model structure. Such models may have billions or even hundreds of billions of parameters, may process massive data, and may have strong learning and generalization capabilities. The emergence of large models has promoted the development and application of the AI technology. In some aspects, a model in this disclosure (which may be a multi-task model) may be a large model.

Hadamard product may correspond to a matrix calculation operation in machine learning. Different from a matrix multiplication, the Hadamard product performs an operation of multiplying corresponding matrix elements at the same position. Two multiplied matrices may have the same number of rows and columns.

MTL may correspond to a learning manner in which a plurality of relevant tasks are learned simultaneously through one multi-task model, where the tasks correspond to respective loss functions. For example, in a recommendation system, a plurality of relevant tasks includes a task of predicting a click-through rate, a reading duration, whether to forward, whether to like recommended content of a user, and the like. In a search system, a plurality of relevant tasks includes a task of predicting a click-through rate of a user for a search result, a reading duration, whether to copy, whether to add to favorites, and the like. In an advertisement system, a plurality of relevant tasks includes a task of predicting a click-through rate and a conversion rate of a user on an advertisement, and the like.

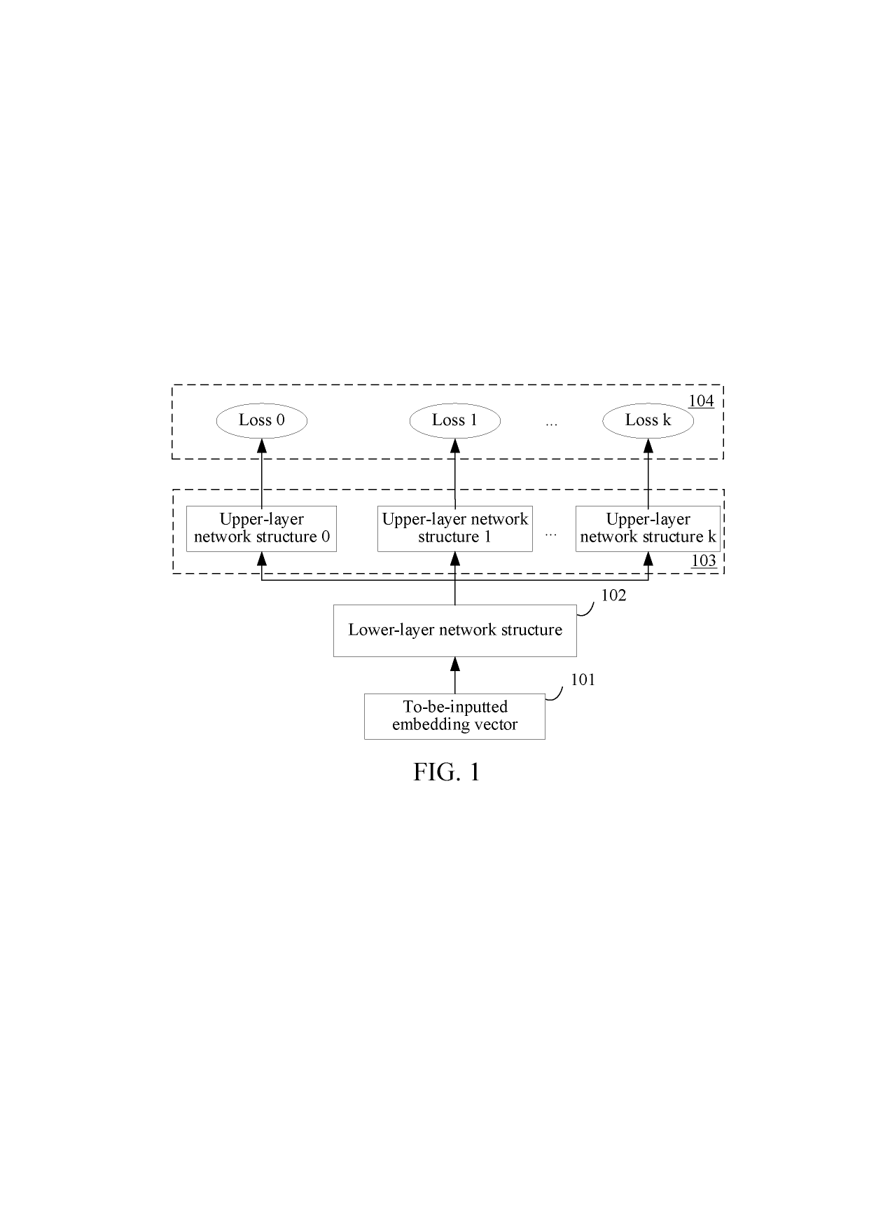

In some applications, a multi-task model may be configured with a parameter-sharing network for a plurality of tasks at a lower layer, and may retain an independent task tower for each task at an upper layer. FIG. 1 shows a multi-task model. A to-be-inputted embedding vector 101 is inputted into a lower-layer network structure 102 to obtain an intermediate vector. The intermediate vector is inputted into a plurality of upper-layer network structures 103 (including task tower 0, task tower 1, …, and task tower k), and training is performed through a plurality of losses 104 (including loss 0, loss 1, …, and loss k). The plurality of upper-layer network structures 103 are in one-to-one correspondence with a plurality of tasks, and the upper-layer network structures are trained according to respective loss functions. Task tower refers to a network structure located at a logical upper layer and related to each task in a multi-task learning model. Each task tower corresponds to a specific task and is configured to predict the task. In this disclosure, the plurality of upper-layer network structures are in one-to-one correspondence with the plurality of tasks. Each upper-layer network structure is a task tower, and task prediction is performed based on the intermediate vector outputted by the lower-layer network structure.

Schematically, in a recommendation system, a user-side feature (e.g., a user ID) and a recommended content-side feature (e.g., a recommended content ID) are both subjected to an embedding operation, and then inputted into the lower-layer network structure 102. The lower-layer network structure 102 performs feature fusion on the user-side feature and the recommended content-side feature to obtain an intermediate vector with better effect and stronger representation capability. The intermediate vector is then transmitted to each upper-layer network structure, and each upper-layer network structure respectively performs a task of predicting a click-through rate, a reading duration, whether to forward, whether to like, and the like.

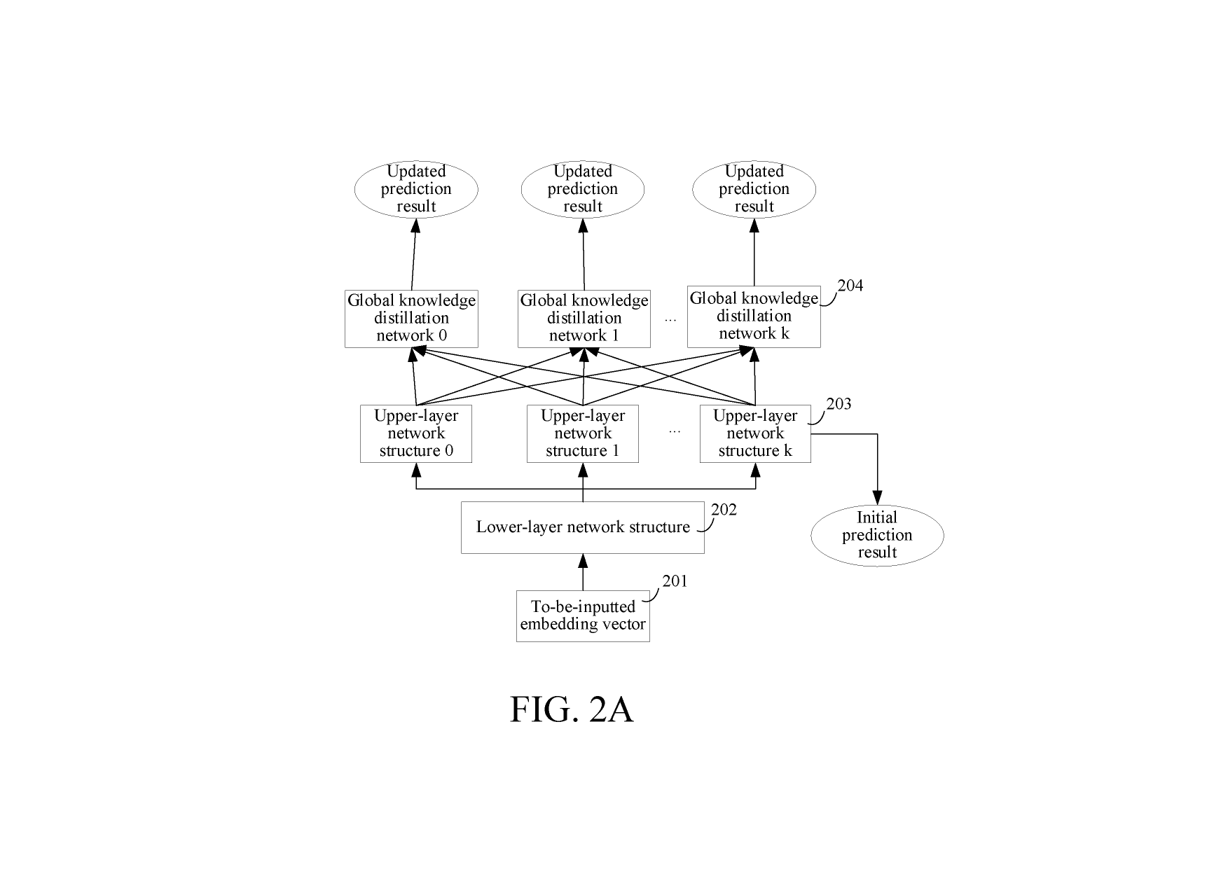

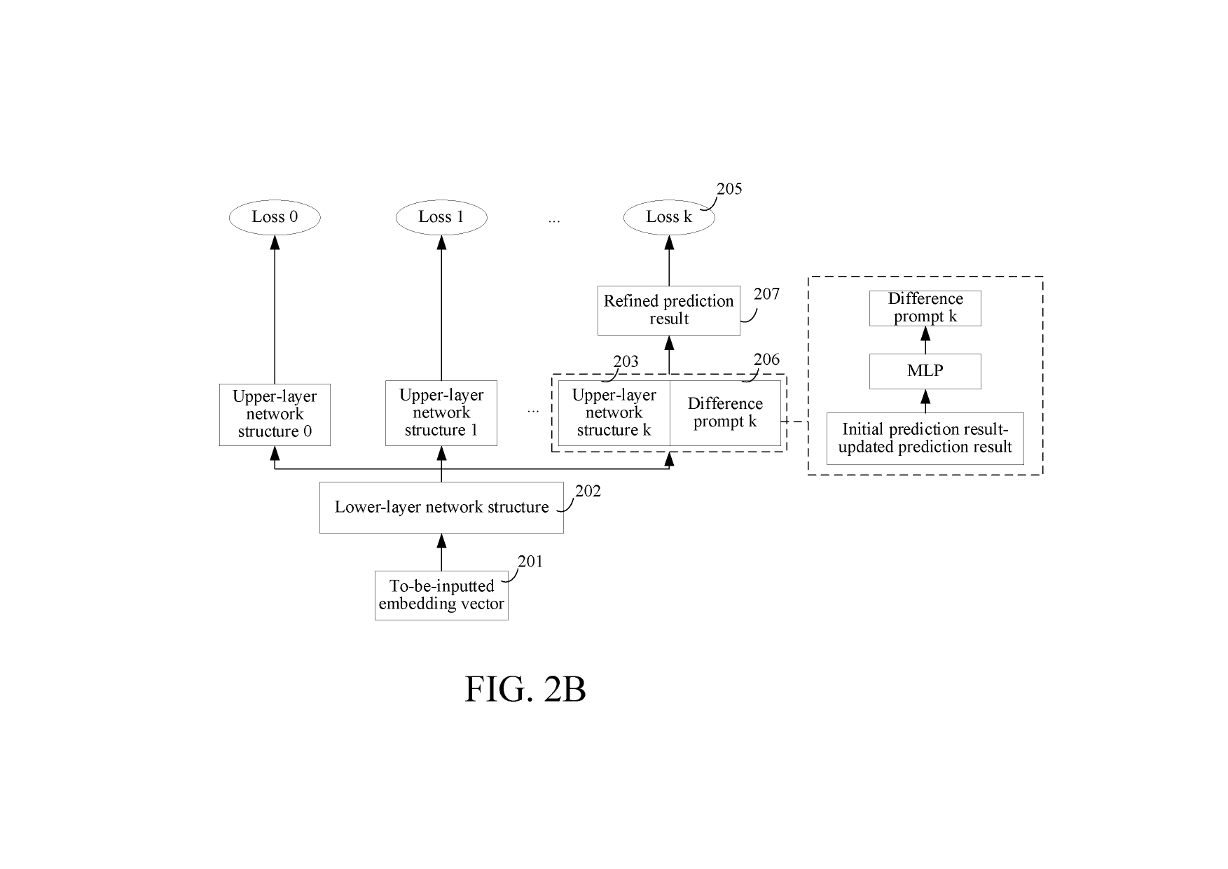

FIGS. 2A and 2B are schematic diagrams of a model-based prediction method according to an aspect of this disclosure. An input of the multi-task model is a to-be-inputted embedding vector 201. The multi-task model includes a lower-layer network structure 202 located at a logical lower layer and a plurality of parallel upper-layer network structures (including an upper-layer network structure k 203) located at a logical upper layer. A network branch of each task includes the lower-layer network structure 202 and one upper-layer network structure.

In FIG. 2A, the to-be-inputted embedding vector 201 is inputted into the lower-layer network structure 202. An intermediate vector (not shown) outputted by the lower-layer network structure 202 is inputted into each upper-layer network structure (K upper-layer network structures in the figure). For the upper-layer network structure k 203, the upper-layer network structure k 203 performs an initial prediction of a k^{th} task based on the intermediate vector, and the upper-layer network structure k 203 outputs an initial prediction result of the k^{th} task. The lower-layer network structure is a shared backbone bottom for the plurality of tasks. The plurality of upper-layer network structures is in one-to-one correspondence with the plurality of tasks, and the upper-layer network structures may also be referred to as task towers.

In a global knowledge distillation network k 204, a plurality of network layer outputs of the plurality of upper-layer network structures are aggregated to obtain global knowledge information. The plurality of upper-layer network structures is in one-to-one correspondence with the plurality of network layer outputs. Based on the global knowledge information and the network layer output of the upper-layer network structure k 203, an updated prediction result of the k^{th} task is obtained through prediction. The network layer output includes an output of the upper-layer network structure before passing through a logits layer (result layer), namely, an upper-layer output of the logits layer. A logits value outputted by the logits layer is the initial prediction result.

The global knowledge information represents comprehensive prediction information jointly reflected by at least two tasks. For example, if task 0 is a task of predicting a click-through rate of recommended content, task 1 is a task of predicting a reading duration of the recommended content, and task k is a task of predicting whether to like the recommended content, the global knowledge information represents a comprehensive judgment from a higher perspective of user satisfaction with the recommended content. In this disclosure, after fusing the network layer output and the global knowledge information, sub-task prediction is performed again to obtain a prediction result after global knowledge information regression, namely the updated prediction result.

In FIG. 2B, a difference prompt k 206 is obtained based on a difference value between the initial prediction result of the upper-layer network structure k 203 and the updated prediction result outputted by the global knowledge distillation network k 204. In an aspect, a difference value between the initial prediction result and the updated prediction result is calculated to obtain a first difference value. An embedding operation is performed on the first difference value to obtain the difference prompt k 206, where the difference prompt k 206 is a prompt in a latent space. In some aspects, the first difference value is inputted into a multi-layer perceptron (MLP) to perform the embedding operation.

Latent space refers to an abstract vector space obtained by coding original data in machine learning and deep learning. In this disclosure, a target latent space may be a vector space where a feature embedding vector inputted into the lower-layer network structure is located, and the difference prompt may be located in the latent space. A latent space prompt does not require the difference prompt to be a real text representation. Instead, a text vector may be learned in the latent space, which lies in the same vector space as an embedding vector of each token in the lower-layer network structure. The feature embedding vector refers to a vector obtained by mapping original discrete features (e.g., texts or categories) into a continuous low-dimensional vector space. In this disclosure, the feature embedding vector may be a vector obtained by performing an embedding operation on a user-side feature (e.g., a user ID) and a recommended content-side feature (e.g., a recommended content ID), and may be inputted into the lower-layer network structure for feature fusion.

The difference prompt k 206 is returned to the upper-layer network structure k 203 to guide the upper-layer network structure k 203 to correct the initial prediction result, to obtain a refined prediction result 207 of a k^{th} task. Model training of the k^{th} task may be performed through loss k 205. In an aspect, the difference prompt k 206 and the network layer output of the upper-layer network structure k 203 are concatenated to obtain an intermediate concatenation result, and the intermediate concatenation result is inputted into a result layer (logits layer) to obtain the refined prediction result 207.

This disclosure adopts a technology of prompt learning. Guided by a difference prompt, an upper-layer network structure performs self-correction by comparing an initial prediction result and an updated prediction result, so that the guidance effect of a global knowledge information may be better utilized, which may help improve the accuracy of prediction results of sub-tasks and the directional consistency of the prediction results of the plurality of tasks.

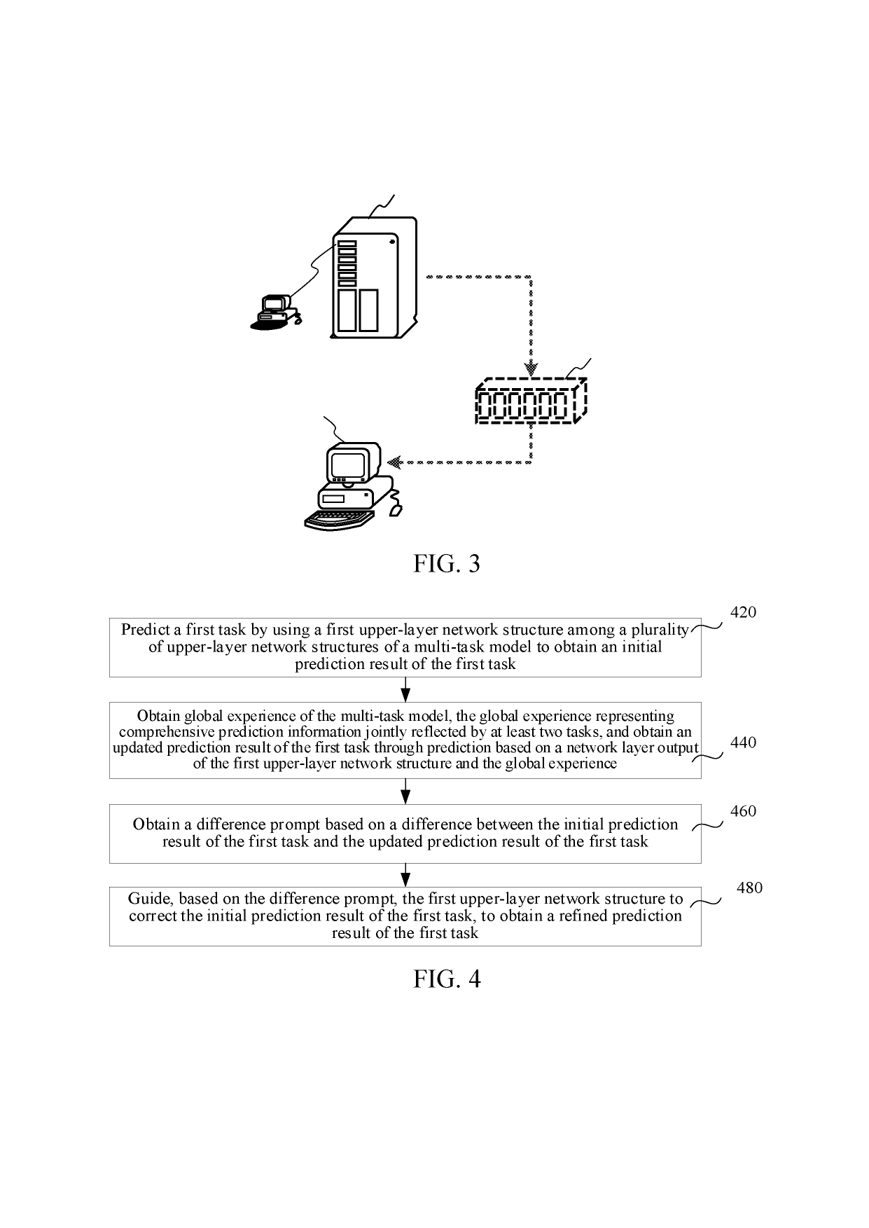

FIG. 3 is a schematic diagram of a multi-task system according to an aspect of this disclosure. FIG. 3 shows a training device 310 for a multi-task model and a usage device 320 for the multi-task model.

During the training process, the training device 310 performs training using the model-based prediction method shown in FIGS. 2A and 2B. A loss k 205 is obtained based on a refined prediction result and a k^{th} label of a sample, and a network related to a k^{th} task is trained based on the loss k 205. The k^{th} label of the sample (e.g., Label of the k-th Sample) refers to a real label or a target value corresponding to the k^{th} task for each sample in a training dataset. In this disclosure, the multi-task model compares a refined prediction result of the k^{th} task, to calculate a loss function, thereby training the network related to the k^{th} task.

During the usage process, the usage device 320 performs reasoning using a prediction method for a multi-task model similar to that shown in FIGS. 2A and 2B. During the first reasoning, an initial prediction result outputted by an upper-layer network structure k 203 and an updated prediction result outputted by a global knowledge distillation network k 204 are obtained. During the second reasoning, a difference prompt is obtained based on a difference between the initial prediction result and the updated prediction result, to guide the upper-layer network structure k 203 to correct the initial prediction result and obtain a refined prediction result. By analogy, during an i^{th} reasoning, an (i-1)^{th} difference prompt is obtained based on a difference between an i^{th} prediction result and the updated prediction result. The upper-layer network structure k 203 is guided based on the (i-1)^{th} difference prompt to correct the i^{th} prediction result to obtain an (i+1)^{th} prediction result. i is an integer with an initial value of two. When i is equal to two, the i^{th} prediction result is the refined prediction result, and the (i-1)^{th} prediction result is the initial prediction result.

In an aspect, the training device 310 includes at least one of a terminal device or a server. The usage device 320 includes at least one of a terminal device or a server. A device type of the terminal device includes at least one of a smartphone, a smart watch, a vehicle-mounted terminal, a wearable device, a smart television, a tablet computer, an e-book reader, a moving picture experts group audio layer III (MP3) player, a moving picture experts group audio layer IV (MP4) player, a laptop portable computer, or a desktop computer. In some aspects, the server may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network, big data, or an AI platform.

Information involved in this disclosure (including but not limited to user equipment information, recommended content features, or advertisement features), data (including but not limited to data for analysis, stored data, or displayed data) and signals may be obtained with user authorization or sufficient authorization from relevant parties. The collection, use, and processing of relevant data may comply with the laws, regulations, and standards of the relevant countries and regions. For example, the recommended content features and the advertisement features involved in this disclosure may be obtained with full authorization. Moreover, with regard to relevant information, a relevant information handler may abide by the principles of lawfulness, legitimacy, and necessity, specify the purpose, manner, and scope of the relevant information processing, obtain the consent of a relevant information subject, and adopt necessary technical and organizational measures to help guarantee the security of the relevant information.

FIG. 4 is a flowchart of a model-based prediction method according to an aspect of this disclosure. In some aspects, a model in FIG. 4 corresponds to a multi-task model. The multi-task model includes a lower-layer network structure located at a logical lower layer and a plurality of parallel upper-layer network structures located at a logical upper layer. A network branch of each task includes the lower-layer network structure and one upper-layer network structure. In an example, the method may be performed by a computer device, and the method may include the following operations as non-limiting examples.

Operation 420: Predict a first task by using a first upper-layer network structure among a plurality of upper-layer network structures of a multi-task model to obtain an initial prediction result of a first task. For example, an initial prediction result of a first task is generated through a first upper-layer network structure of a plurality of upper-layer network structures of a multi-task model based on a lower-layer output of a lower-layer network structure of the multi-task model.

The multi-task model refers to a model configured to simultaneously predict a plurality of relevant tasks. In a recommendation system, a plurality of relevant tasks include a task of predicting a click-through rate, a reading duration, whether to forward, whether to like recommended content of a user, and the like. In a search system, a plurality of relevant tasks include a task of predicting a click-through rate of a user for a search result, a reading duration, whether to copy, whether to add to favorites, and the like. In an advertisement system, a plurality of relevant tasks include a task of predicting a click-through rate and a conversion rate of a user on an advertisement, and the like.

The multi-task model includes a lower-layer network structure located at a logical lower layer and a plurality of parallel upper-layer network structures located at a logical upper layer. The lower-layer network structure may be a shared backbone bottom for a plurality of relevant tasks. In some aspects, the backbone bottom is configured to fuse a user-side feature and a recommendation content-side feature to obtain an intermediate feature. For example, in the backbone bottom, a user ID, a recommended content ID, a category ID of recommended content, and the like may be subjected to feature concatenation via a concat layer. Then, the feature embedding may be mapped to a lower dimension via a dense layer, to obtain an intermediate feature. In some aspects, the lower-layer network structure may be any one of multi-gate mixture-of-experts (MMOE), progressive layered extraction (PLE), or multiple-level sparse sharing model (MSSM). The intermediate feature refers to a feature extracted by a layer between an input layer and an output layer during neural network processing. In this disclosure, the intermediate feature may be a feature obtained by feature fusion of the user-side feature and the recommended content-side feature through the lower-layer network structure, may have better representation capability, and may be used for subsequent task prediction in the upper-layer network structure.

The upper-layer network structure is often referred to as a task tower (Tower for short). The plurality of upper-layer network structures are configured to predict a plurality of tasks, and the plurality of upper-layer network structures are in one-to-one correspondence with the plurality of tasks. The plurality of upper-layer network structures are separately designed network structures associated with the tasks.

In an aspect, prediction results of the tasks are outputted via the plurality of upper-layer network structures, to obtain initial prediction results of the plurality of tasks. For one of the tasks, namely a first task, an initial prediction result of the first task may be obtained, where the first task may be a designated task or any one of the plurality of tasks.

Operation 440: Obtain global knowledge information of the multi-task model, the global knowledge information representing comprehensive prediction information jointly reflected by at least two tasks, and obtain an updated prediction result of the first task through prediction based on a network layer output of the first upper-layer network structure and the global knowledge information. For example, global knowledge information is generated based on an output of the first upper-layer network structure and an output of each of one or more other upper-layer network structures of the plurality of upper-layer network structures.

The global knowledge information represents comprehensive prediction information jointly reflected by at least two tasks (a plurality of tasks). The global knowledge information is a higher-level comprehensive judgment from a global perspective on prediction information of at least two tasks (a plurality of tasks). The prediction information may be a network layer output of the upper-layer network structure, a prediction result, and the like. For example, in a recommendation system, a plurality of relevant tasks include a task of predicting a click-through rate, a reading duration, and interaction of a user with respect to recommended content. The prediction results of the plurality of relevant tasks all reflect the user satisfaction with the recommended content from different levels and different perspectives. The global knowledge information represents the user satisfaction with the recommended content.

For the first task, the network layer output of the first upper-layer network structure is fused with the global knowledge information. Then, the prediction of the first task is performed again to obtain an updated prediction result of the first task. The network layer output includes an output of the upper-layer network structure before passing through a logits layer (result layer), namely, an upper-layer output of the logits layer. A logits value outputted by the logits layer is the prediction result.

Operation 460: Obtain a difference prompt based on a difference between the initial prediction result of the first task and the updated prediction result of the first task. For example, a difference prompt is generated based on a difference between the initial prediction result of the first task and the updated prediction result of the first task.

In an aspect, a difference value between the initial prediction result of the first task and the updated prediction result of the first task is calculated to obtain a first difference value. An embedding operation is performed on the first difference value to obtain a difference prompt. The difference prompt may be located in a target latent space. The target latent space may be a vector space where a feature embedding vector inputted into the lower-layer network structure is located.

In some aspects, the first difference value is inputted into a first MLP to perform the embedding operation, to obtain the difference prompt.

In a related technology, a common construction method for a prompt is manual construction, in which an appropriate text template is designed for a target problem, and the prompt based on a specified text template guides the model to correct the prediction result. However, the text template may rely on manual experience, making it difficult to better guarantee the effect. In this disclosure, a latent space prompt (difference prompt) may be constructed. The latent space prompt does not require the difference prompt to be a real text representation. Instead, a text vector may be learned in the latent space. The difference prompt may not be mapped to a specific token, but may be located in the same vector space as embedding vectors of respective tokens in the lower-layer network structure. The latent space prompt does not rely on manually designed text templates, and the latent space prompt may be more flexible with better effect.

Moreover, the difference prompt constructed in this disclosure may be clear and explicit with strong interpretability, enabling the model to accurately understand requirements and perform relevant operations through the difference prompt.

In some aspects, the first difference value is inputted into a first MLP to perform the embedding operation, to obtain the difference prompt. This aspect provides a method for mapping a difference into a latent space prompt (difference prompt) through an MLP, which may be simple and convenient in operation.

Operation 480: Guide, based on the difference prompt, the first upper-layer network structure to correct the initial prediction result of the first task, to obtain a refined prediction result of the first task. For example, a refined prediction result of the first task is generated through the first upper-layer network structure based on the difference prompt and the initial prediction result of the first task.

The difference prompt is inputted into the first upper-layer network structure, to guide the first upper-layer network structure to correct the initial prediction result of the first task, to obtain a refined prediction result of the first task.

In an aspect, the difference prompt and the network layer output of the first upper-layer network structure are concatenated to obtain an intermediate concatenation result. The intermediate concatenation result is inputted into a result layer (logits layer) of the first upper-layer network structure to obtain the refined prediction result of the first task.

In this disclosure, the difference prompt is returned to the task for guidance and prompting. The first upper-layer network structure performs backtracking correction according to the difference prompt between a prediction result and a subsequent prediction result, and re-predicts a sub-task objective to obtain the refined prediction result of the first task.

In this disclosure, guided by the difference prompt, the model performs self-correction by comparing a prediction result and a subsequent prediction result, thereby better utilizing the guiding effect of global knowledge information. This is the significance of introducing the prompt, which may not only improve the accuracy of a final prediction result of each sub-task, but may also improve a task consistency indicator of prediction results of a plurality of tasks. The task consistency indicator will be described separately below.

The task consistency indicator indicates whether the prediction results of the plurality of upper-layer network structures are consistent in direction. A plurality of prediction result means (each prediction result mean is a mean of a plurality of refined prediction results obtained by performing one task on a plurality of test samples) in one-to-one correspondence with a plurality of tasks are obtained. Test samples in which the refined prediction result of each task is greater than the prediction result mean corresponding to the task among the plurality of test samples are counted (to obtain a first quantity). Moreover, test samples in which the refined prediction result of each task is less than the prediction result mean corresponding to the task among the plurality of test samples are counted (to obtain a second quantity). A sum of the first quantity and the second quantity is divided by a total quantity (the total quantity is a quantity of the plurality of test samples) to obtain the indicator. A higher value of the indicator may indicate that the overall prediction results of the plurality of tasks are relatively accurate. A lower value may indicate that the overall prediction results of the plurality of tasks are relatively inaccurate.

In some examples, the method may further include generating the lower-layer output through the lower-layer network structure of the multi-task model based on an audience feature of a target audience and a content feature of a piece of content. In some examples, the plurality of upper-layer network structures corresponds to predicting a plurality of respective reactions of the target audience to the piece of content. In some examples, the piece of content to the target audience is presented based on a ranking that is determined based on the refined prediction result of the first task.

In addition, some applications may be based on an adaptive information transfer multi-task (AITM) framework. AITM may enhance knowledge transfer among task towers. However, AITM framework may be applied to tasks with sequential dependencies, such as click-through rate estimation and conversion rate estimation. In contrast, the framework provided in this disclosure may be applied to various sub-tasks with a parallel relationship, and is not limited to sequential dependencies. Moreover, the framework of this disclosure is compatible with various multi-task basic models. Offline and online experiments prove that the model-based prediction method proposed in this disclosure may improve the accuracy and consistency of multi-task objective prediction, thereby improving service indicators.

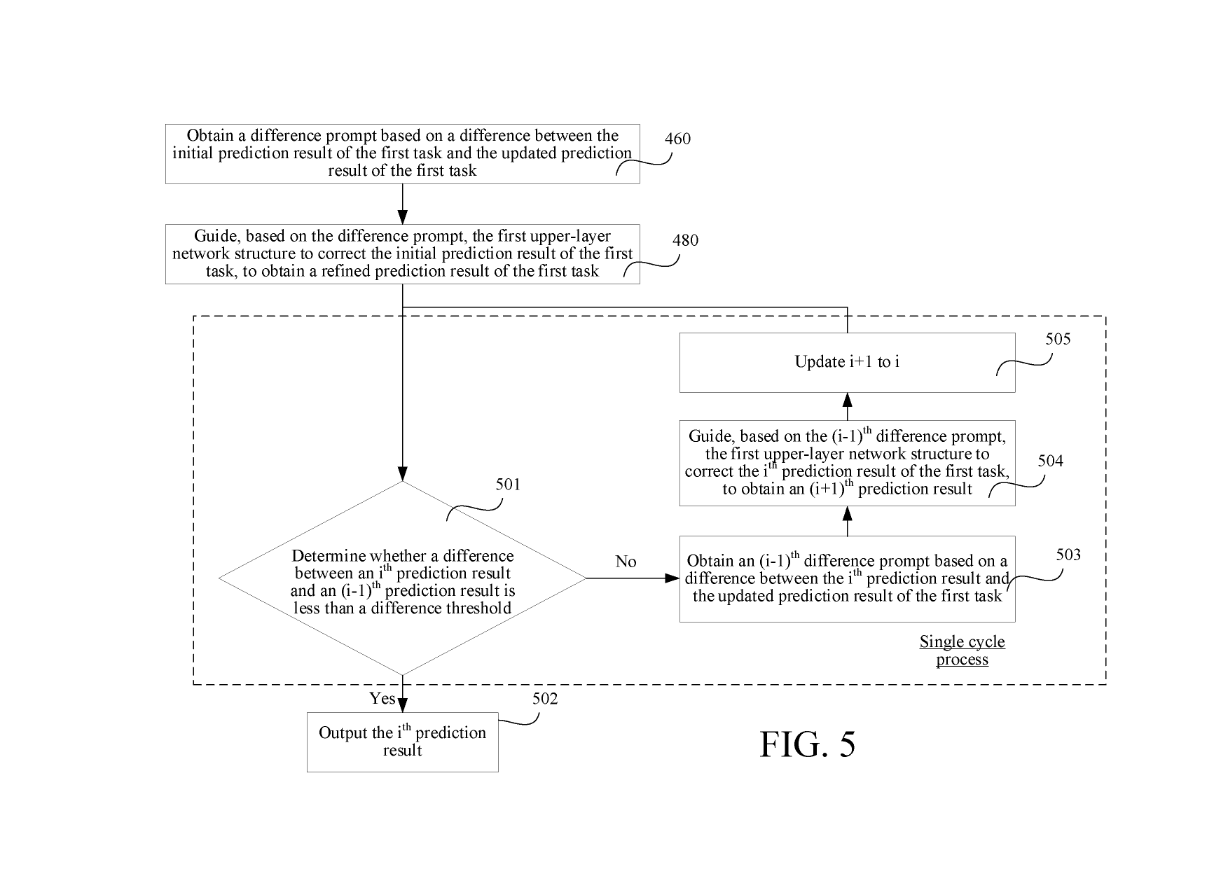

In the aspect shown in FIG. 4, one guidance correction is performed on the first upper-layer network structure, and the obtained refined prediction result is not necessarily the most accurate prediction result. Therefore, the following aspect introduces a method for cyclically correcting the prediction result continuously. After operation 480 shown in FIG. 4, the method operations shown in FIG. 5 may be further performed. FIG. 5 shows a single cycle process. The operations in the single cycle process may include:

Operation 501: Determine whether a difference between an i^{th} prediction result and an (i-1)^{th} prediction result is less than a difference threshold.

i is a positive integer not less than one, i has an initial value of two, when i is equal to two, the i^{th} prediction result is the refined prediction result of the first task, and the (i-1)^{th} prediction result is the initial prediction result of the first task.

The difference threshold refers to a pre-set parameter during model prediction, which may be configured to determine the degree of difference between two adjacent prediction results so as to determine whether to continue correcting the prediction result. When the difference between the i^{th} prediction result and the (i-1)^{th} prediction result is less than the difference threshold, the i^{th} prediction result obtained at this time may be regarded as a relatively accurate answer and may be outputted. When the difference is not less than the threshold, a difference prompt may be obtained based on the difference between the i^{th} prediction result and the updated prediction result, so as to correct the prediction result.

In an example, when entering a cycle structure for the first time, the process determines whether a difference between the refined prediction result and the initial prediction result is less than a difference threshold. If the difference is less than the difference threshold, operation 502 is performed. If the difference is not less than the difference threshold, operation 503 is performed. The difference threshold is a pre-set parameter.

When entering the cycle structure for an (i-1)^{th} time, it is determined whether a difference between an i^{th} prediction result and an (i-1)^{th} prediction result is less than a difference threshold. If the difference is less than the difference threshold, operation 502 is performed. If the difference is not less than the difference threshold, operation 503 is performed. The difference threshold is a pre-set parameter.

Schematically, if the i^{th} prediction result of the first task is 10 s (reading duration), the (i-1)^{th} prediction result is 5 s (reading duration), and the difference threshold is 2 s, it is determined that the difference (5 s) between the i^{th} prediction result and the (i-1)^{th} prediction result is not less than the difference threshold.

Operation 502: Output, in a case that the difference between the i^{th} prediction result and the (i-1)^{th} prediction result is less than the difference threshold, the i^{th} prediction result.

If the difference between the i^{th} prediction result and the (i-1)^{th} prediction result is less than the difference threshold, the i^{th} prediction result obtained at this time is regarded as a correct answer, and the i^{th} prediction result may be outputted.

Operation 503: Obtain, in a case that the difference between the i^{th} prediction result and the (i-1)^{th} prediction result is not less than the difference threshold, an (i-1)^{th} difference prompt based on a difference between the i^{th} prediction result and the updated prediction result of the first task.

If the difference between the i^{th} prediction result and the (i-1)^{th} prediction result is not less than the difference threshold, the i^{th} prediction result obtained at this time may be regarded as an incorrect result, and may be re-corrected. In this aspect, the (i-1)^{th} difference prompt may be obtained based on the difference between the i^{th} prediction result and the updated prediction result of the first task.

Continuing with the foregoing example, the i^{th} prediction result of the first task is 10 s, and the updated prediction result is 20 s. The (i-1)^{th} difference prompt is obtained based on the difference (10 s) between the i^{th} prediction result and the updated prediction result.

Operation 504: Guide, based on the (i-1)^{th} difference prompt, the first upper-layer network structure to correct the i^{th} prediction result of the first task, to obtain an (i+1)^{th} prediction result.

Continuing with the foregoing example, based on the (i-1)^{th} difference prompt, the first upper-layer network structure is guided to correct the i^{th} prediction result (10 s) of the first task, to obtain an (i+1)^{th} prediction result (11 s).

Operation 505: Update i+1 to i, and proceed to the cycle process again.

In the foregoing aspects, whether the difference between two adjacent prediction results is sufficiently large may be used as a cycle end condition. If the difference between two adjacent prediction results is small, the difference may indicate that the model is not able to further correct the result, and the prediction result obtained at this time may be regarded as a correct answer. In the foregoing aspects, the process of human reasoning may be simulated by continuously executing the cycle process, and the reasoning accuracy may be improved by repeatedly checking and correcting the prediction result.

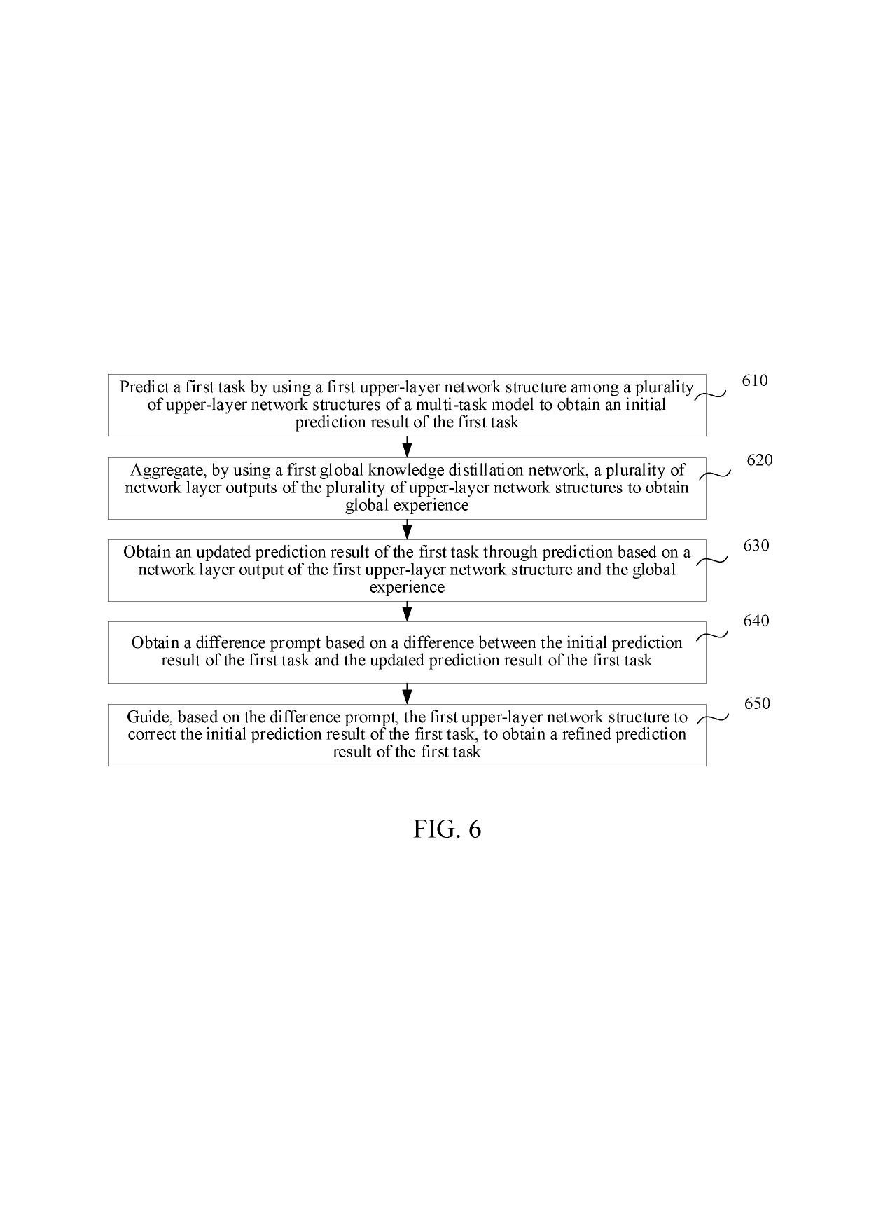

FIG. 6 is a flowchart of a model-based prediction method according to an aspect of this disclosure. A multi-task model includes a lower-layer network structure, a plurality of parallel upper-layer network structures, and a plurality of parallel global knowledge distillation networks. A network branch of each task includes the lower-layer network structure, one upper-layer network structure, and one global knowledge distillation network. In an example, the method may be performed by a computer device, and the method may include:

Operation 610: Predict a first task by using a first upper-layer network structure among a plurality of upper-layer network structures of a multi-task model to obtain an initial prediction result of a first task.

The multi-task model refers to a model configured to simultaneously predict a plurality of relevant tasks. In a recommendation system, a plurality of relevant tasks include a task of predicting a click-through rate, a reading duration, whether to forward, whether to like recommended content of a user, and the like. In a search system, a plurality of relevant tasks include a task of predicting a click-through rate of a user for a search result, a reading duration, whether to copy, whether to add to favorites, and the like. In an advertisement system, a plurality of relevant tasks include a task of predicting a click-through rate and a conversion rate of a user on an advertisement, and the like.

The multi-task model includes a lower-layer network structure located at a logical lower layer and a plurality of parallel upper-layer network structures located at a logical upper layer. The lower-layer network structure may be a shared backbone bottom for a plurality of relevant tasks. In some aspects, the backbone bottom is configured to fuse a user-side feature and a recommendation content-side feature to obtain an intermediate feature.

The upper-layer network structure is often referred to as a task tower (Tower for short). The plurality of upper-layer network structures are configured to predict a plurality of tasks, and the plurality of upper-layer network structures are in one-to-one correspondence with the plurality of tasks. The plurality of upper-layer network structures are separately designed network structures associated with the tasks.

In an aspect, prediction results of the tasks are outputted via the plurality of upper-layer network structures, to obtain initial prediction results of the plurality of tasks. For one of the tasks, namely a first task, an initial prediction result of the first task may be obtained, where the first task may be a designated task or any one of the plurality of tasks.

Operation 620: Aggregate, by using a first global knowledge distillation network, a plurality of network layer outputs of the plurality of upper-layer network structures to obtain global knowledge information. In some examples, the multi-task model includes a plurality of network branches, each network branch of the plurality of network branches corresponding to a respective task of a plurality of tasks and including a respective one of the plurality of upper-layer network structures and a respective global knowledge distillation network, the plurality of tasks including the first task and at least one additional task. In some examples, the output of the first upper-layer network structure in the network branch of the first task and the output of each of the one or more other upper-layer network structures of the plurality of upper-layer network structures in the network branch of each of the at least one additional task may be aggregated by using a first global knowledge distillation network in the network branch of the first task.

In an aspect, the plurality of network layer outputs of the plurality of upper-layer network structures are aggregated by using the first global knowledge distillation network to obtain global knowledge information. The global knowledge information represents comprehensive prediction information jointly reflected by at least two tasks (a plurality of tasks). The network layer output includes an output of the upper-layer network structure before passing through a logits layer, namely, an upper-layer output of the logits layer. A logits value outputted by the logits layer is the prediction result.

In an aspect, the first global knowledge distillation network includes a second MLP. The plurality of network layer outputs of the plurality of upper-layer network structures are concatenated to obtain a concatenation result, and the concatenation result is inputted into the second MLP to obtain the global knowledge information.

The global knowledge information is a higher-perspective comprehensive judgment from a global perspective on prediction information of at least two tasks (a plurality of tasks). The prediction information may be a network layer output of the upper-layer network structure, a prediction result, and the like. For example, in a recommendation system, a plurality of relevant tasks include a task of predicting a click-through rate, a reading duration, and interaction of a user with respect to recommended content. The prediction results of the plurality of relevant tasks all reflect the user satisfaction with the recommended content from different levels and different perspectives. The global knowledge information represents the user satisfaction with the recommended content.

In this aspect, a generation method for global knowledge information is provided, which has relatively low invasiveness to original upper-layer network structures and adds a global knowledge distillation network with slight model modification.

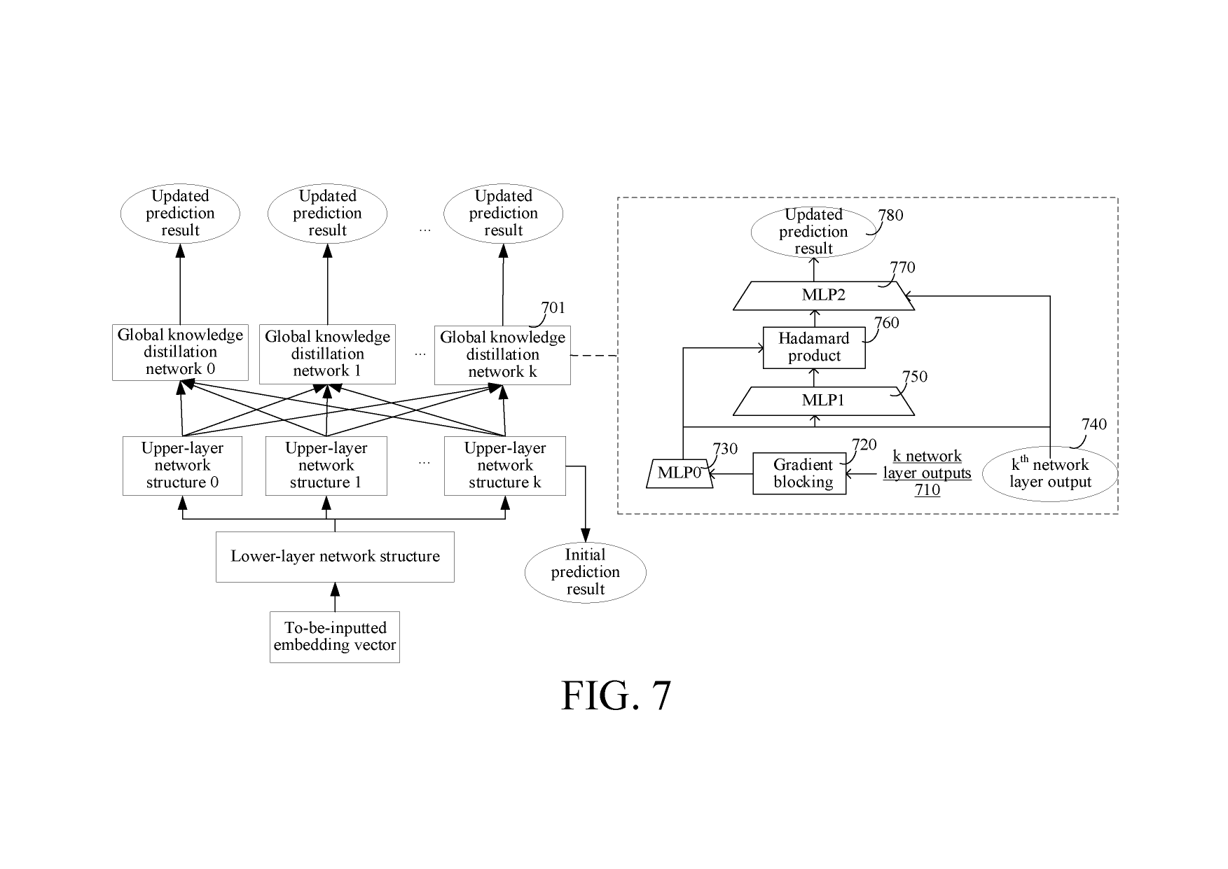

Referring to FIG. 7, a global knowledge distillation network k701 is shown in FIG. 7.

In the global knowledge distillation network k 701, gradient blocking 720 is performed on a plurality of network layer outputs (k network layer outputs) 710 of a plurality of upper-layer network structures (upper-layer network structure 0, upper-layer network structure 1, …, and upper-layer network structure k), and then the plurality of network layer outputs of the plurality of upper-layer network structures are concatenated to obtain a concatenation result. The concatenation result is inputted into a second MLP (MLP0) 730 to obtain global knowledge information. Gradient blocking refers to an operation of preventing back-propagation of gradients in a part of the network during neural network training. In this disclosure, gradient blocking is performed on the plurality of network layer outputs of the plurality of upper-layer network structures, so as to avoid affecting original task outputs when learning the global knowledge information from the plurality of network layer outputs. The network layer output refers to an output of the upper-layer network structure before passing through a logits layer (result layer). A logits value outputted by the logits layer is an initial prediction result. This disclosure provides a manner of generating global knowledge information through an MLP, which may be simple in operation and strong in interpretability.

Operation 630: Obtain an updated prediction result of the first task through prediction based on a network layer output of the first upper-layer network structure and the global knowledge information.

In an aspect, for the first upper-layer network structure, an attention weight of the first upper-layer network structure with respect to the global knowledge information is calculated, and the global knowledge information is applied to the first task. Sub-objective prediction is performed again by using a fused result of the global knowledge information and the network layer output of the first upper-layer network structure, to obtain the updated prediction result of the first task.

In an aspect, by using a first global knowledge distillation network, an attention weight of the network layer output of the first upper-layer network structure with respect to the global knowledge information is calculated to obtain a first reference weight, the first reference weight being a reference weight corresponding to the first task. In some aspects, the first global knowledge distillation network includes a third MLP. The network layer output of the first upper-layer network structure and the global knowledge information are inputted into the third MLP to obtain the first reference weight, a last network layer of the third MLP being a softmax layer. Both the first reference weight and the global knowledge information are matrices. In this aspect, the first reference weight is obtained through the third MLP, which may be simple in operation.

The softmax layer refers to a network layer that processes inputs using a softmax function in a neural network. The softmax function converts a real vector into a probability distribution, so that each element in the vector ranges from 0 to 1 and the sum of all elements is 1. In this disclosure, the last network layer of the third MLP may be a softmax layer, configured to calculate an attention weight of the network layer output of the first upper-layer network structure with respect to the global knowledge information, to obtain the first reference weight.

A weighting operation is performed on the global knowledge information by using the first reference weight to obtain first reference experience, the first reference experience representing experience related to the first task in the global knowledge information. The first reference experience is a matrix.

The updated prediction result of the first task is obtained through prediction based on the first reference experience and the network layer output of the first upper-layer network structure. In some aspects, if the first global knowledge distillation network includes a fourth MLP, the first reference experience and the network layer output of the first upper-layer network structure are inputted into the fourth MLP, and the updated prediction result of the first task is obtained through prediction. In this aspect, refined prediction is performed through the fourth MLP, and the model structure may be relatively simple.

In this disclosure, an attention mechanism may be adopted to obtain valuable reference experience from the global knowledge information. The attention mechanism may implement selection of the global knowledge information, enable the model to focus on noteworthy information in the global knowledge information, and further improve the accuracy of the updated prediction result.

Schematically, with reference to FIG. 7, global knowledge information (GK^{k}) is outputted by MLP0 730. The global knowledge information and a network layer output (k^{th} network layer output) 740 of a k^{th} upper-layer network structure are inputted into a third MLP (MLP1) 750 to obtain a k^{th} reference weight (GW^{k}). A last network layer of the third MLP 750 is a softmax layer. A Hadamard product 760 operation is performed on the global knowledge information and the k^{th} reference weight to obtain a k^{th} reference knowledge information (WGK^{k}). The k^{th} reference knowledge information represents knowledge information referenced from the global knowledge information. The k^{th} reference knowledge information and the network layer output (k^{th} network layer output) 740 of the k^{th} upper-layer network structure are inputted into a fourth MLP (MLP2) 770, and a k^{th} task is predicted again to obtain an updated prediction result 780 of the k^{th} task. The Hadamard product operation refers to an operation of multiplying matrix elements at the same positions in two matrices.

Operation 640: Obtain a difference prompt based on a difference between the initial prediction result of the first task and the updated prediction result of the first task.

In an aspect, a difference value between the initial prediction result of the first task and the updated prediction result of the first task is calculated to obtain a first difference value.

An embedding operation is performed on the first difference value to obtain the difference prompt, the difference prompt being located in a target latent space, and the target latent space being a vector space where a feature embedding vector inputted into a lower-layer network structure is located.

In some aspects, the first difference value is inputted into a first MLP to perform the embedding operation, to obtain the difference prompt.

Operation 650: Guide, based on the difference prompt, the first upper-layer network structure to correct the initial prediction result of the first task, to obtain a refined prediction result of the first task.

The difference prompt is inputted into the first upper-layer network structure, to guide the first upper-layer network structure to correct the initial prediction result of the first task, to obtain a refined prediction result of the first task.

In an aspect, the difference prompt and the network layer output of the first upper-layer network structure are concatenated to obtain an intermediate concatenation result. The intermediate concatenation result is inputted into a result layer (logits layer) of the first upper-layer network structure to obtain the refined prediction result of the first task.

In this disclosure, the difference prompt is returned to the task for guidance and prompting. The first upper-layer network structure performs backtracking correction according to the difference prompt between a prediction result and a subsequent prediction result, and re-predicts a sub-task objective to obtain the refined prediction result of the first task.

During the experimental stage, this disclosure constructs a task consistency indicator. The task consistency indicator is configured to indicate whether the prediction results of the plurality of upper-layer network structures are consistent in direction.

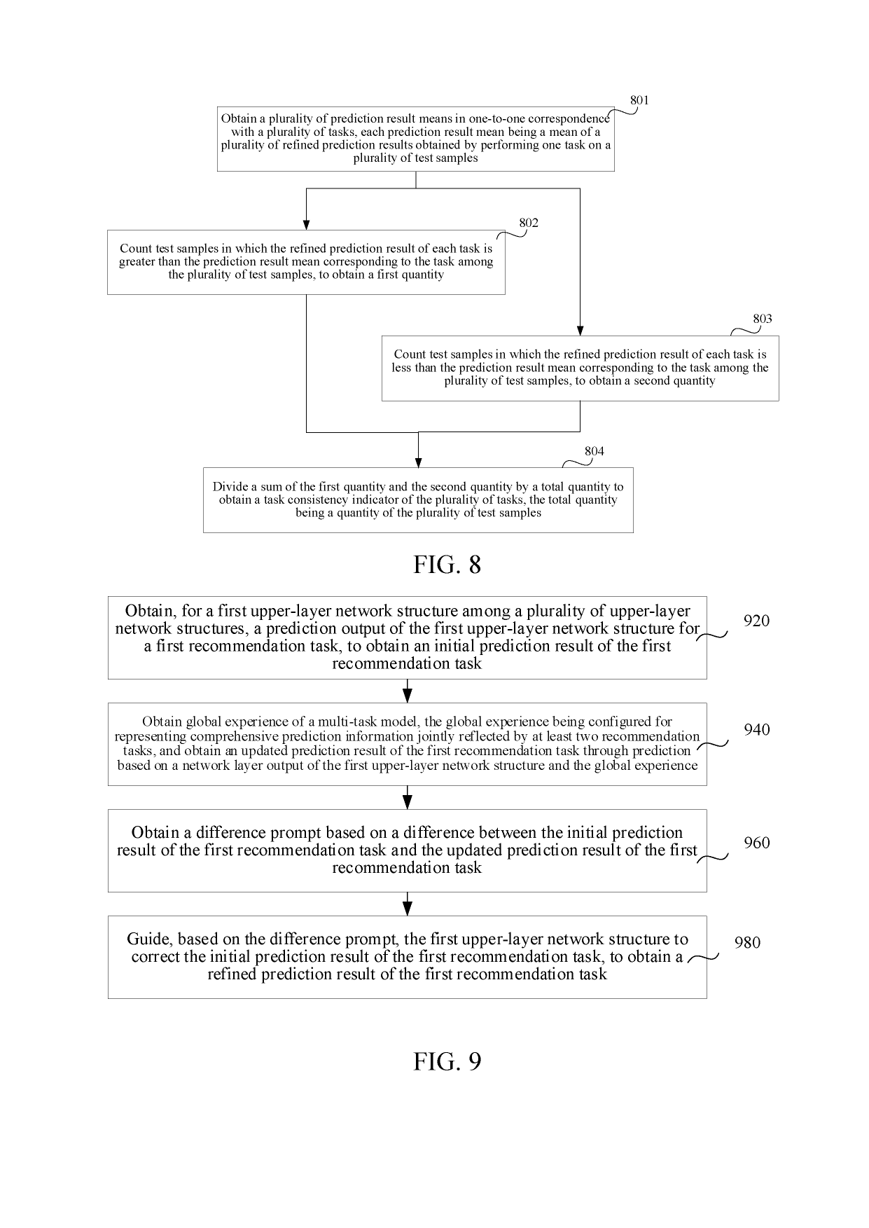

FIG. 8 is a flowchart of a method for constructing a task consistency indicator according to an aspect of this disclosure. In an example, the method may be performed by a computer device, and the method may include:

Operation 801: Obtain a plurality of prediction result means in one-to-one correspondence with a plurality of tasks, each prediction result mean being a mean of a plurality of refined prediction results obtained by performing one task on a plurality of test samples.

The prediction result mean refers to a mean of a plurality of refined prediction results obtained by performing one task on a plurality of test samples. For example, for a task of reading duration, a mean of reading durations (refined prediction results) of a plurality of test samples is a prediction result mean of the task. For a task of predicting a click-through rate, a mean of click-through rates (refined prediction results) of a plurality of test samples is a prediction result mean of the task.

A plurality of test samples are obtained, such as a plurality of recommendation items. For one task, a plurality of refined prediction results of a plurality of test samples are outputted, and a mean of the plurality of refined prediction results is calculated to obtain a prediction result mean.

For example, for a task of reading duration, a mean of reading durations (refined prediction results) of a plurality of test samples is 20 s. For a task of predicting a click-through rate, a mean of click-through rates (refined prediction results) of a plurality of test samples obtained through prediction is 0.5.

Operation 802: Count test samples in which the refined prediction result of each task is greater than the prediction result mean corresponding to the task among the plurality of test samples, to obtain a first quantity.

For example, the plurality of test samples include sample 1, sample 2, sample 3, sample 4, and sample 5. If a refined prediction result of sample 1 for task 1 is greater than a prediction result mean of task 1, a refined prediction result of sample 1 for task 2 is greater than a prediction result mean of task 2, and a refined prediction result of sample 1 for task 3 is greater than a prediction result mean of task 3, it is determined that multi-task prediction results of sample 1 are consistent (all greater than the corresponding prediction result means).

In an example, multi-task prediction results of sample 1 and sample 2 may statistically be determined to be all greater than the corresponding prediction result means. The multi-task prediction results of sample 1 and sample 2 are thus consistent.

Operation 803: Count test samples in which the refined prediction result of each task is less than the prediction result mean corresponding to the task among the plurality of test samples, to obtain a second quantity.

For example, the plurality of test samples include sample 1, sample 2, sample 3, sample 4, and sample 5. If a refined prediction result of sample 3 for task 1 is less than a prediction result mean of task 1, a refined prediction result of sample 3 for task 2 is less than a prediction result mean of task 2, and a refined prediction result of sample 3 for task 3 is less than a prediction result mean of task 3, it is determined that multi-task prediction results of sample 3 are consistent (all less than the corresponding prediction result means).

In an example, multi-task prediction results of sample 3 and sample 4 may statistically be determined to be all less than the corresponding prediction result means. The multi-task prediction results of sample 3 and sample 4 are thus consistent.

Operation 804: Divide a sum of the first quantity and the second quantity by a total quantity to obtain a task consistency indicator of the plurality of tasks, the total quantity being a quantity of the plurality of test samples.

A sum of a first quantity (two) and a second quantity (two) is divided by a total quantity (five) to obtain a task consistency indicator of 4/5 of a plurality of tasks.

The task consistency indicator constructed in the foregoing aspects may be configured to measure the directional consistency of prediction results of the plurality of tasks. For example, the task consistency indicator of 1 includes the following scenarios: The prediction results of the plurality of tasks may reflect that a user is highly satisfied with recommended content. The prediction results of the plurality of tasks may reflect that the user is moderately satisfied with the recommended content. The prediction results of the plurality of tasks may reflect that the user is relatively dissatisfied with the recommended content. A higher value of the task consistency indicator may indicate that the overall prediction results of the plurality of tasks are relatively accurate. A lower value of the task consistency indicator may indicate that the overall prediction results of the plurality of tasks are relatively inaccurate.

For multi-task model prediction (e.g., a baseline method) performed without adopting the method of this disclosure, considering a click-through rate prediction task and an interaction task, a value of an obtained task consistency indicator of the two tasks may be 0.799632.

For multi-task model prediction (e.g., this disclosure) performed by adopting the method of this disclosure, considering a click-through rate prediction task and an interaction task, a value of an obtained task consistency indicator of the two tasks may be 0.808475.

Therefore, with respect to the task consistency indicator, this disclosure may achieve an improvement of 0.008843 compared with the baseline method.

The model-based prediction method described in the foregoing aspects may be applied to a recommendation system. A model-based prediction method applied to a recommendation system is described below.

FIG. 9 is a model-based prediction method applied to a recommendation system. In some aspects, a model is a multi-task model. The multi-task model includes a lower-layer network structure and a plurality of parallel upper-layer network structures. A network branch of each recommendation task includes the lower-layer network structure and one upper-layer network structure. The method may include:

Operation 920: Predict a first task by using a first upper-layer network structure among a plurality of upper-layer network structures of a multi-task model to obtain an initial prediction result of a first recommendation task.

The recommendation task includes a task of predicting a click-through rate, a reading duration, whether to forward, whether to like recommended content of a user, and the like.

Operation 940: Obtain global knowledge information of the multi-task model, the global knowledge information representing comprehensive prediction information jointly reflected by at least two recommendation tasks, and obtain an updated prediction result of the first recommendation task through prediction based on a network layer output of the first upper-layer network structure and the global knowledge information.

In an aspect, a network branch of each task further includes a global knowledge distillation network. By using a first global knowledge distillation network, a plurality of network layer outputs of the plurality of upper-layer network structures are aggregated to obtain the global knowledge information, the plurality of network layer outputs being in one-to-one correspondence with the plurality of upper-layer network structures. In some aspects, the first global knowledge distillation network includes a second MLP. The plurality of network layer outputs of the plurality of upper-layer network structures are concatenated to obtain a concatenation result, and the concatenation result is inputted into the second MLP to obtain the global knowledge information.

In an aspect, a network branch of each task further includes a global knowledge distillation network. By using a first global knowledge distillation network, an attention weight of the network layer output of the first upper-layer network structure with respect to the global knowledge information is calculated to obtain a first reference weight, the first reference weight being a reference weight corresponding to the first recommendation task. In some aspects, the first global knowledge distillation network includes a third MLP. The network layer output of the first upper-layer network structure and the global knowledge information are inputted into the third MLP to obtain the first reference weight, a last network layer of the third MLP being a softmax layer.

A weighting operation is performed on the global knowledge information by using the first reference weight to obtain first reference experience, the first reference experience representing experience related to the first recommendation task in the global knowledge information.

The updated prediction result of the first recommendation task is obtained through prediction based on the first reference experience and the network layer output of the first upper-layer network structure. In some aspects, if the first global knowledge distillation network includes a fourth MLP, the first reference experience and the network layer output of the first upper-layer network structure are inputted into the fourth MLP, and the updated prediction result of the first recommendation task is obtained through prediction.

Operation 960: Obtain a difference prompt based on a difference between the initial prediction result of the first recommendation task and the updated prediction result of the first recommendation task.

In an aspect, a difference value between the initial prediction result of the first recommendation task and the updated prediction result of the first recommendation task is calculated to obtain a first difference value. An embedding operation is performed on the first difference value to obtain the difference prompt, the difference prompt being located in a target latent space, and the target latent space being a vector space where a feature embedding vector inputted into a lower-layer network structure is located. In some aspects, the first difference value is inputted into a first MLP to perform the embedding operation, to obtain the difference prompt.

Operation 980: Guide, based on the difference prompt, the first upper-layer network structure to correct the initial prediction result of the first recommendation task, to obtain a refined prediction result of the first recommendation task.

In an aspect, the difference prompt and the network layer output of the first upper-layer network structure are concatenated to obtain an intermediate concatenation result. The intermediate concatenation result is inputted into a result layer of the first upper-layer network structure to obtain the refined prediction result of the first recommendation task.

In an aspect, in a single cycle process, an i^{th} prediction result is outputted when a difference between the i^{th} prediction result and an (i-1)^{th} prediction result is less than a difference threshold, i being an integer with an initial value of two, when i is equal to two, the i^{th} prediction result being the refined prediction result of the first recommendation task, and the (i-1)^{th} prediction result being the initial prediction result of the first recommendation task. When the difference between the i^{th} prediction result and the (i-1)^{th} prediction result is not less than the difference threshold, an (i-1)^{th} difference prompt is obtained based on a difference between the i^{th} prediction result and the updated prediction result of the first recommendation task, the first upper-layer network structure is guided based on the (i-1)^{th} difference prompt to correct the i^{th} prediction result to obtain an (i+1)^{th} prediction result, i+1 is updated to i, and the cycle process proceeds again.

In an aspect, a plurality of prediction result means in one-to-one correspondence with a plurality of recommendation tasks are obtained, each prediction result mean being a mean of a plurality of refined prediction results obtained by performing one recommendation task on a plurality of test samples. Test samples in which the refined prediction result of each recommendation task is greater than the prediction result mean corresponding to the recommendation task among the plurality of test samples are counted, to obtain a first quantity. Moreover, test samples in which the refined prediction result of each recommendation task is less than the prediction result mean corresponding to the recommendation task among the plurality of test samples are counted, to obtain a second quantity. A sum of the first quantity and the second quantity is divided by a total quantity to obtain a task consistency indicator of the plurality of recommendation tasks, the total quantity being a quantity of the plurality of test samples.

In this disclosure, a difference prompt is constructed based on a difference between an updated prediction result (a prediction result obtained by prediction integrating global knowledge information) and an initial prediction result, and a first upper-layer network structure is then guided to correct the initial prediction result of a first task by using the difference prompt. This disclosure provides a prediction architecture of a prompt-based multi-task model. A prompt mechanism is introduced to better use guidance of global knowledge information (the global knowledge information represents comprehensive prediction information jointly reflected by at least two tasks) to correct and guide a prediction result from a higher layer, which may improve accuracy of a prediction result of each recommendation task, and may also improve directional consistency of prediction results of a plurality of recommendation tasks. For example, the prediction results of the plurality of recommendation tasks may reflect that a user is relatively satisfied with recommended content, or the prediction results of the plurality of recommendation tasks may reflect that the user is relatively dissatisfied with the recommended content.

The model-based prediction method described in the foregoing aspects may be applied to an advertisement system. A model-based prediction method applied to an advertisement system is described below.

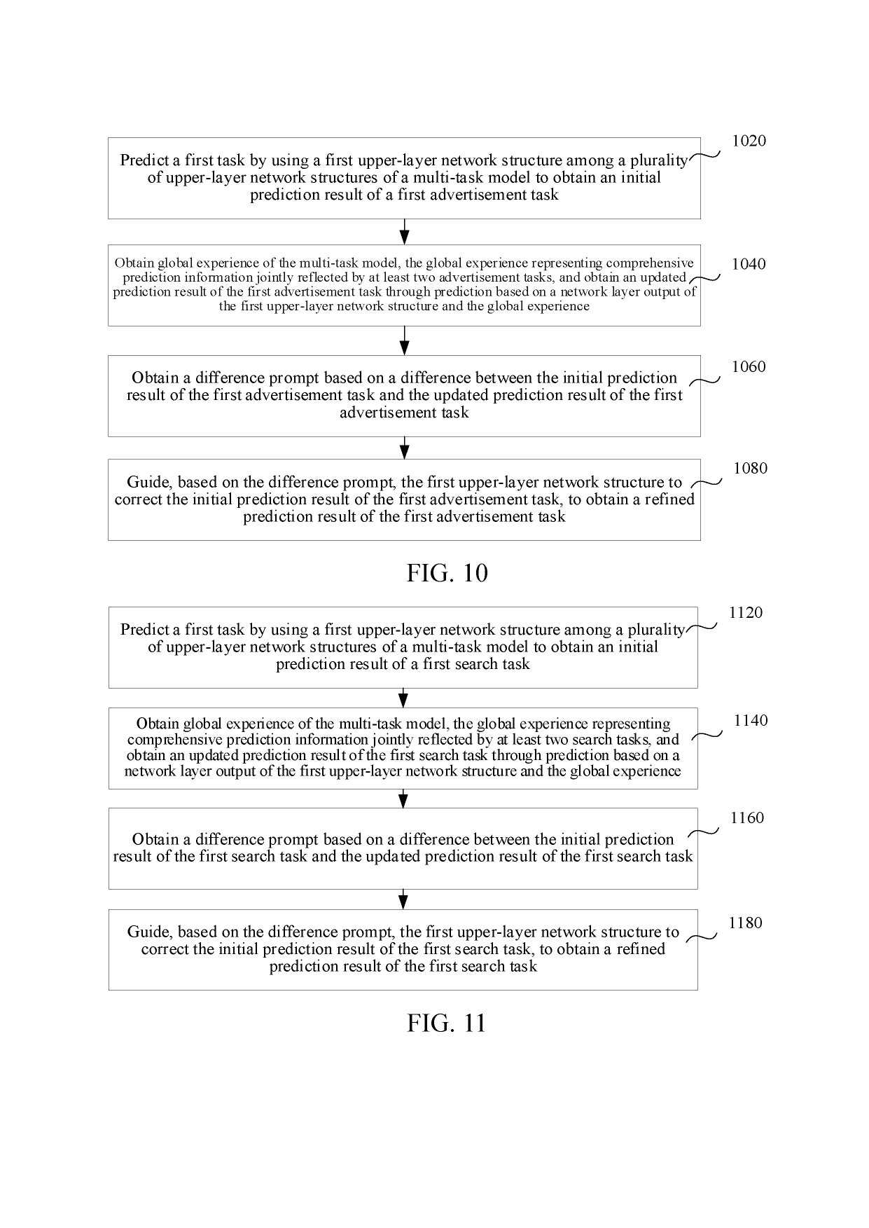

FIG. 10 is a model-based prediction method applied to an advertisement system. In some aspects, a model is a multi-task model. The multi-task model includes a lower-layer network structure located at a logical lower layer and a plurality of parallel upper-layer network structures located at a logical upper layer. A network branch of each advertisement task includes the lower-layer network structure and one upper-layer network structure. The method may include:

Operation 1020: Predict a first task by using a first upper-layer network structure among a plurality of upper-layer network structures of a multi-task model to obtain an initial prediction result of a first advertisement task.

The advertisement task includes a task of predicting a click-through rate and a conversion rate of a user on an advertisement, and the like.

Operation 1040: Obtain global knowledge information of the multi-task model, the global knowledge information representing comprehensive prediction information jointly reflected by at least two advertisement tasks, and obtain an updated prediction result of the first advertisement task through prediction based on a network layer output of the first upper-layer network structure and the global knowledge information.

In an aspect, a network branch of each task further includes a global knowledge distillation network. By using a first global knowledge distillation network, a plurality of network layer outputs of the plurality of upper-layer network structures are aggregated to obtain the global knowledge information, the plurality of network layer outputs being in one-to-one correspondence with the plurality of upper-layer network structures. In some aspects, the first global knowledge distillation network includes a second MLP. The plurality of network layer outputs of the plurality of upper-layer network structures are concatenated to obtain a concatenation result, and the concatenation result is inputted into the second MLP to obtain the global knowledge information.

In an aspect, a network branch of each task further includes a global knowledge distillation network. By using a first global knowledge distillation network, an attention weight of the network layer output of the first upper-layer network structure with respect to the global knowledge information is calculated to obtain a first reference weight, the first reference weight being a reference weight corresponding to the first advertisement task. In some aspects, the first global knowledge distillation network includes a third MLP. The network layer output of the first upper-layer network structure and the global knowledge information are inputted into the third MLP to obtain the first reference weight, a last network layer of the third MLP being a softmax layer.

A weighting operation is performed on the global knowledge information by using the first reference weight to obtain first reference experience, the first reference experience representing experience related to the first advertisement task in the global knowledge information.

The updated prediction result of the first advertisement task is obtained through prediction based on the first reference experience and the network layer output of the first upper-layer network structure. In some aspects, if the first global knowledge distillation network includes a fourth MLP, the first reference experience and the network layer output of the first upper-layer network structure are inputted into the fourth MLP, and the updated prediction result of the first advertisement task is obtained through prediction.

Operation 1060: Obtain a difference prompt based on a difference between the initial prediction result of the first advertisement task and the updated prediction result of the first advertisement task.

In an aspect, a difference value between the initial prediction result of the first advertisement task and the updated prediction result of the first advertisement task is calculated to obtain a first difference value. An embedding operation is performed on the first difference value to obtain the difference prompt, the difference prompt being located in a target latent space, and the target latent space being a vector space where a feature embedding vector inputted into a lower-layer network structure is located. In some aspects, the first difference value is inputted into a first MLP to perform the embedding operation, to obtain the difference prompt.

Operation 1080: Guide, based on the difference prompt, the first upper-layer network structure to correct the initial prediction result of the first advertisement task, to obtain a refined prediction result of the first advertisement task.

In an aspect, the difference prompt and the network layer output of the first upper-layer network structure are concatenated to obtain an intermediate concatenation result. The intermediate concatenation result is inputted into a result layer of the first upper-layer network structure to obtain the refined prediction result of the first advertisement task.

In an aspect, in a single cycle process, an i^{th} prediction result is outputted when a difference between the i^{th} prediction result and an (i-1)^{th} prediction result is less than a difference threshold, i being an integer with an initial value of two, when i is equal to two, the i^{th} prediction result being the refined prediction result of the first advertisement task, and the (i-1)^{th} prediction result being the initial prediction result of the first advertisement task. When the difference between the i^{th} prediction result and the (i-1)^{th} prediction result is not less than the difference threshold, an (i-1)^{th} difference prompt is obtained based on a difference between the i^{th} prediction result and the updated prediction result of the first advertisement task, the first upper-layer network structure is guided based on the (i-1)^{th} difference prompt to correct the i^{th} prediction result to obtain an (i+1)^{th} prediction result, i+1 is updated to i, and the cycle process proceeds again.

In an aspect, a plurality of prediction result means in one-to-one correspondence with a plurality of advertisement tasks are obtained, each prediction result mean being a mean of a plurality of refined prediction results obtained by performing one advertisement task on a plurality of test samples. Test samples in which the refined prediction result of each advertisement task is greater than the prediction result mean corresponding to the advertisement task among the plurality of test samples are counted, to obtain a first quantity. Moreover, test samples in which the refined prediction result of each advertisement task is less than the prediction result mean corresponding to the advertisement task among the plurality of test samples are counted, to obtain a second quantity. A sum of the first quantity and the second quantity is divided by a total quantity to obtain a task consistency indicator of the plurality of advertisement tasks, the total quantity being a quantity of the plurality of test samples.

In this disclosure, a difference prompt is constructed based on a difference between an updated prediction result (a prediction result obtained by prediction integrating global knowledge information) and an initial prediction result, and a first upper-layer network structure is then guided to correct the initial prediction result of a first task by using the difference prompt. This disclosure provides a prediction architecture of a prompt-based multi-task model. A prompt mechanism is introduced to better use guidance of global knowledge information (the global knowledge information represents comprehensive prediction information jointly reflected by at least two tasks) to correct and guide a prediction result from a higher layer, which may improve accuracy of a prediction result of each advertisement task, and may also improve directional consistency of prediction results of a plurality of advertisement tasks. For example, the prediction results of the plurality of advertisement tasks may reflect that a user is more interested in advertisement content, or the prediction results of the plurality of advertisement tasks may reflect that the user is less interested in the advertisement content.

The model-based prediction method described in the foregoing aspects may be applied to a search system. A model-based prediction method applied to a search system is described below.

FIG. 11 is a model-based prediction method applied to a search system. In some aspects, a model is a multi-task model. The multi-task model includes a lower-layer network structure and a plurality of parallel upper-layer network structures. A network branch of each search task includes the lower-layer network structure and one upper-layer network structure. The method may include:

Operation 1120: Predict a first task by using a first upper-layer network structure among a plurality of upper-layer network structures of a multi-task model to obtain an initial prediction result of a first search task.

The search task includes a task of predicting a click-through rate of a user for a search result, a reading duration, whether to copy, whether to add to favorites, and the like.

Operation 1140: Obtain global knowledge information of the multi-task model, the global knowledge information representing comprehensive prediction information jointly reflected by at least two search tasks, and obtain an updated prediction result of the first search task through prediction based on a network layer output of the first upper-layer network structure and the global knowledge information.

In an aspect, a network branch of each task further includes a global knowledge distillation network. By using a first global knowledge distillation network, a plurality of network layer outputs of the plurality of upper-layer network structures are aggregated to obtain the global knowledge information, the plurality of network layer outputs being in one-to-one correspondence with the plurality of upper-layer network structures. In some aspects, the first global knowledge distillation network includes a second MLP. The plurality of network layer outputs of the plurality of upper-layer network structures are concatenated to obtain a concatenation result, and the concatenation result is inputted into the second MLP to obtain the global knowledge information.

In an aspect, a network branch of each task further includes a global knowledge distillation network. By using a first global knowledge distillation network, an attention weight of the network layer output of the first upper-layer network structure with respect to the global knowledge information is calculated to obtain a first reference weight, the first reference weight being a reference weight corresponding to the first search task. In some aspects, the first global knowledge distillation network includes a third MLP. The network layer output of the first upper-layer network structure and the global knowledge information are inputted into the third MLP to obtain the first reference weight, a last network layer of the third MLP being a softmax layer.

A weighting operation is performed on the global knowledge information by using the first reference weight to obtain first reference experience, the first reference experience representing experience related to the first search task in the global knowledge information. The updated prediction result of the first search task is obtained through prediction based on the first reference experience and the network layer output of the first upper-layer network structure. In some aspects, if the first global knowledge distillation network includes a fourth MLP, the first reference experience and the network layer output of the first upper-layer network structure are inputted into the fourth MLP, and the updated prediction result of the first search task is obtained through prediction.

Operation 1160: Obtain a difference prompt based on a difference between the initial prediction result of the first search task and the updated prediction result of the first search task.

In an aspect, a difference value between the initial prediction result of the first search task and the updated prediction result of the first search task is calculated to obtain a first difference value. An embedding operation is performed on the first difference value to obtain the difference prompt, the difference prompt being located in a target latent space, and the target latent space being a vector space where a feature embedding vector inputted into a lower-layer network structure is located. In some aspects, the first difference value is inputted into a first MLP to perform the embedding operation, to obtain the difference prompt.

Operation 1180: Guide, based on the difference prompt, the first upper-layer network structure to correct the initial prediction result of the first search task, to obtain a refined prediction result of the first search task.

In an aspect, the difference prompt and the network layer output of the first upper-layer network structure are concatenated to obtain an intermediate concatenation result. The intermediate concatenation result is inputted into a result layer of the first upper-layer network structure to obtain the refined prediction result of the first search task.

In an aspect, in a single cycle process, an i^{th} prediction result is outputted when a difference between the i^{th} prediction result and an (i-1)^{th} prediction result is less than a difference threshold, i being an integer with an initial value of two, when i is equal to two, the i^{th} prediction result being the refined prediction result of the first search task, and the (i-1)^{th} prediction result being the initial prediction result of the first search task. When the difference between the i^{th} prediction result and the (i-1)^{th} prediction result is not less than the difference threshold, an (i-1)^{th} difference prompt is obtained based on a difference between the i^{th} prediction result and the updated prediction result of the first search task, the first upper-layer network structure is guided based on the (i-1)^{th} difference prompt to correct the i^{th} prediction result to obtain an (i+1)^{th} prediction result, i+1 is updated to i, and the cycle process proceeds again.

In an aspect, a plurality of prediction result means in one-to-one correspondence with a plurality of search tasks are obtained, each prediction result mean being a mean of a plurality of refined prediction results obtained by performing one search task on a plurality of test samples. Test samples in which the refined prediction result of each search task is greater than the prediction result mean corresponding to the search task among the plurality of test samples are counted, to obtain a first quantity. Moreover, test samples in which the refined prediction result of each search task is less than the prediction result mean corresponding to the search task among the plurality of test samples are counted, to obtain a second quantity. A sum of the first quantity and the second quantity is divided by a total quantity to obtain a task consistency indicator of the plurality of search tasks, the total quantity being a quantity of the plurality of test samples.

In this disclosure, a difference prompt is constructed based on a difference between an updated prediction result (a prediction result obtained by prediction integrating global knowledge information) and an initial prediction result, and a first upper-layer network structure is then guided to correct the initial prediction result of a first task by using the difference prompt. This disclosure provides a prediction architecture of a prompt-based multi-task model. A prompt mechanism is introduced to better use guidance of global knowledge information (the global knowledge information represents comprehensive prediction information jointly reflected by at least two tasks) to correct and guide a prediction result from a higher layer, which may improve accuracy of a prediction result of each search task, and may also improve directional consistency of prediction results of a plurality of search tasks. For example, the prediction results of the plurality of search tasks may reflect that a user is relatively satisfied with a search result, or the prediction results of the plurality of search tasks may reflect that the user is relatively dissatisfied with the search result.

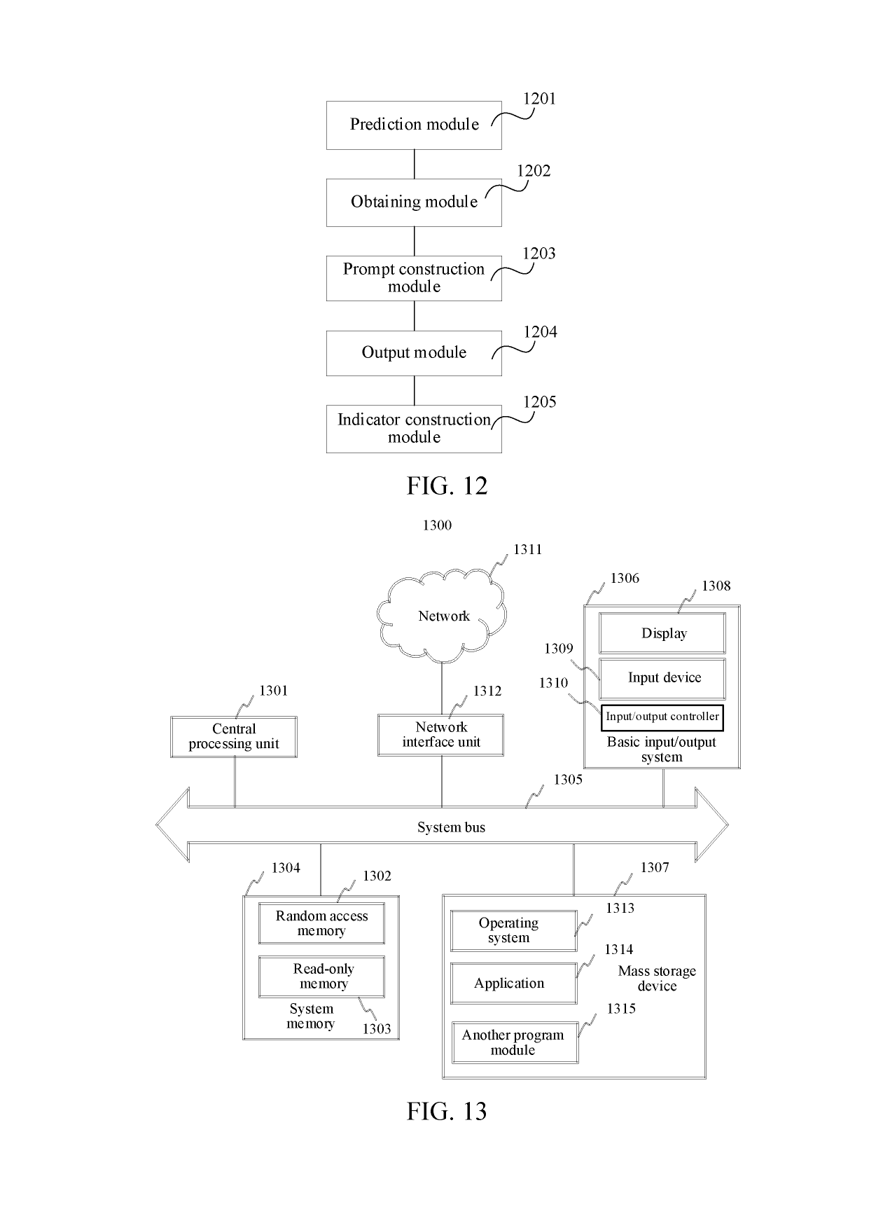

FIG. 12 is a structural block diagram of a model-based prediction apparatus according to an aspect of this disclosure. In some aspects, a model is a multi-task model. The multi-task model includes a lower-layer network structure and a plurality of parallel upper-layer network structures. A network branch of each task includes the lower-layer network structure and one upper-layer network structure. The apparatus may include:

a prediction module 1201, configured to predict a first task by using a first upper-layer network structure among a plurality of upper-layer network structures of a multi-task model to obtain an initial prediction result of the first task;

an obtaining module 1202, configured to obtain global knowledge information of the multi-task model, the global knowledge information representing comprehensive prediction information jointly reflected by at least two tasks, and

the prediction module 1201 being further configured to obtain an updated prediction result of the first task through prediction based on a network layer output of the first upper-layer network structure and the global knowledge information; and

a prompt construction module 1203, configured to obtain a difference prompt based on a difference between the initial prediction result of the first task and the updated prediction result of the first task,

the prediction module 1201 being further configured to guide, based on the difference prompt, the first upper-layer network structure to correct the initial prediction result of the first task, to obtain a refined prediction result of the first task.

In an aspect, the prompt construction module 1203 is further configured to: calculate a difference value between the initial prediction result of the first task and the updated prediction result of the first task to obtain a first difference value; and

perform an embedding operation on the first difference value to obtain the difference prompt, the difference prompt being located in a target latent space, and the target latent space being a vector space where a feature embedding vector inputted into a lower-layer network structure is located.

In an aspect, the prompt construction module 1203 is further configured to input the first difference value into a first MLP to perform the embedding operation, to obtain the difference prompt.

In an aspect, the prediction module 1201 is further configured to concatenate the difference prompt and the network layer output of the first upper-layer network structure to obtain an intermediate concatenation result, and input the intermediate concatenation result into a result layer of the first upper-layer network structure to obtain the refined prediction result of the first task.

In an aspect, the apparatus further includes an output module 1204.

The output module 1204 is configured to output, in a single cycle process, an i^{th} prediction result in a case that a difference between the i^{th} prediction result and an (i-1)^{th} prediction result is less than a difference threshold, i being a positive integer not less than one, i having an initial value of two, when i is equal to two, the i^{th} prediction result being the refined prediction result of the first task, and the (i-1)^{th} prediction result being the initial prediction result of the first task.

The prompt construction module 1203 is further configured to obtain, in a case that the difference between the i^{th} prediction result and the (i-1)^{th} prediction result is not less than the difference threshold, an (i-1)^{th} difference prompt based on a difference between the i^{th} prediction result and the updated prediction result of the first task.

The prediction module 1201 is further configured to guide, based on the (i-1)^{th} difference prompt, the first upper-layer network structure to correct the i^{th} prediction result to obtain an (i+1)^{th} prediction result, update i+1 to i, and proceed to the cycle process again.

In an aspect, a network branch of each task further includes a global knowledge distillation network. The obtaining module 1202 is further configured to aggregate, by using a first global knowledge distillation network, a plurality of network layer outputs of the plurality of upper-layer network structures to obtain the global knowledge information, the plurality of upper-layer network structures being in one-to-one correspondence with the plurality of network layer outputs.

In an aspect, the first global knowledge distillation network includes a second MLP. The obtaining module 1202 is further configured to concatenate the plurality of network layer outputs of the plurality of upper-layer network structures to obtain a concatenation result, and input the concatenation result into the second MLP to obtain the global knowledge information.

In an aspect, a network branch of each task further includes a global knowledge distillation network. The prediction module 1201 is further configured to: calculate, by using a first global knowledge distillation network, an attention weight of the network layer output of the first upper-layer network structure with respect to the global knowledge information to obtain a first reference weight, the first reference weight being a reference weight corresponding to the first task; perform a weighting operation on the global knowledge information by using the first reference weight to obtain first reference experience, the first reference experience representing experience related to the first task in the global knowledge information; and obtain the updated prediction result of the first task through prediction based on the first reference experience and the network layer output of the first upper-layer network structure.

In an aspect, the first global knowledge distillation network includes a third MLP. The prediction module 1201 is further configured to input the network layer output of the first upper-layer network structure and the global knowledge information into the third MLP to obtain the first reference weight, a last network layer of the third MLP being a softmax layer.

In an aspect, the first global knowledge distillation network includes a fourth MLP. The prediction module 1201 is further configured to input the first reference experience and the network layer output of the first upper-layer network structure into the fourth MLP, and obtain the updated prediction result of the first task through prediction.

In an aspect, the apparatus further includes an indicator construction module 1205. The indicator construction module 1205 is configured to: obtain a plurality of prediction result means in one-to-one correspondence with a plurality of tasks, each prediction result mean being a mean of a plurality of refined prediction results obtained by performing one task on a plurality of test samples; count test samples in which the refined prediction result of each task is greater than the prediction result mean corresponding to the task among the plurality of test samples, to obtain a first quantity; count test samples in which the refined prediction result of each task is less than the prediction result mean corresponding to the task among the plurality of test samples, to obtain a second quantity; and divide a sum of the first quantity and the second quantity by a total quantity to obtain a task consistency indicator of the plurality of tasks, the total quantity being a quantity of the plurality of test samples.

In this disclosure, a difference prompt is constructed based on a difference between an updated prediction result (a prediction result obtained by prediction integrating global knowledge information) and an initial prediction result, and a first upper-layer network structure is then guided to correct the initial prediction result of a first task by using the difference prompt. This disclosure provides a prediction architecture of a prompt-based multi-task model. A prompt mechanism is introduced to better use guidance of global knowledge information (the global knowledge information represents comprehensive prediction information jointly reflected by at least two tasks) to correct and guide a prediction result from a higher layer, which may improve accuracy of a prediction result of each task, and may also improve directional consistency of prediction results of a plurality of tasks. For example, the prediction results of the plurality of tasks may reflect that a user is relatively satisfied with recommended content, or the prediction results of the plurality of tasks may reflect that the user is relatively dissatisfied with the recommended content.

FIG. 13 is a schematic structural diagram of a computer device according to an aspect of this disclosure. For example, a computer device 1300 includes processing circuitry (e.g., a central processing unit (CPU) 1301), a system memory 1304 including a random access memory (RAM) 1302 and a read-only memory (ROM) 1303, and a system bus 1305 connecting the system memory 1304 and the CPU 1301. The computer device 1300 further includes a basic input/output (I/O) system 1306 assisting in information transmission between components in the computer device, and a mass storage device 1307 configured to store an operating system 1313, an application 1314, and another program module 1315.

The basic I/O system 1306 includes a display 1308 configured to display information and an input device 1309 such as a mouse or a keyboard for inputting information by a user. The display 1308 and the input device 1309 are both connected to the CPU 1301 by using an I/O controller 1310 connected to the system bus 1305. The basic I/O system 1306 may further include the I/O controller 1310 to be configured to receive and process inputs from a plurality of other devices such as a keyboard, a mouse, and an electronic stylus. Similarly, the I/O controller 1310 further provides an output to a display screen, a printer, or another type of output device.

The mass storage device 1307 is connected to the CPU 1301 by using a mass storage controller (not shown) connected to the system bus 1305. The mass storage device 1307 and a computer device-readable medium associated therewith provide non-volatile storage for the computer device 1300. In other words, the mass storage device 1307 may include a non-transitory computer device-readable medium (not shown) such as a hard disk or a compact disc read-only memory (CD-ROM) drive.

Without loss of generality, the computer device-readable medium may include a computer device storage medium and a communication medium. The computer device storage medium includes volatile and non-volatile media, and removable and non-removable media implemented by using any method or technology for storing information such as computer device readable instructions, data structures, program modules, or other data. The computer device storage medium includes a RAM, a ROM, an erasable programmable ROM (EPROM), an electrically EPROM (EEPROM), a CD-ROM, a digital versatile disc (DVD) or another optical memory, a tape cartridge, a magnetic cassette, a magnetic disk memory, or another magnetic storage device. A person skilled in the art may learn that the computer device storage medium is not limited to the foregoing several types. The system memory 1304 and the mass storage device 1307 may be collectively referred to as a memory.

According to aspects of the present disclosure, the computer device 1300 may be further connected, through a network such as the Internet, to a remote computer device on the network and run. The computer device 1300 may be connected to a network 1311 by using a network interface unit 1312 connected to the system bus 1305, or may be connected to another type of network or a remote computer system (not shown) by using the network interface unit 1312.

The memory further includes one or more programs. The one or more programs are stored in the memory. The CPU 1301 executes the one or more programs to implement all or some of the operations of the foregoing model prediction method.

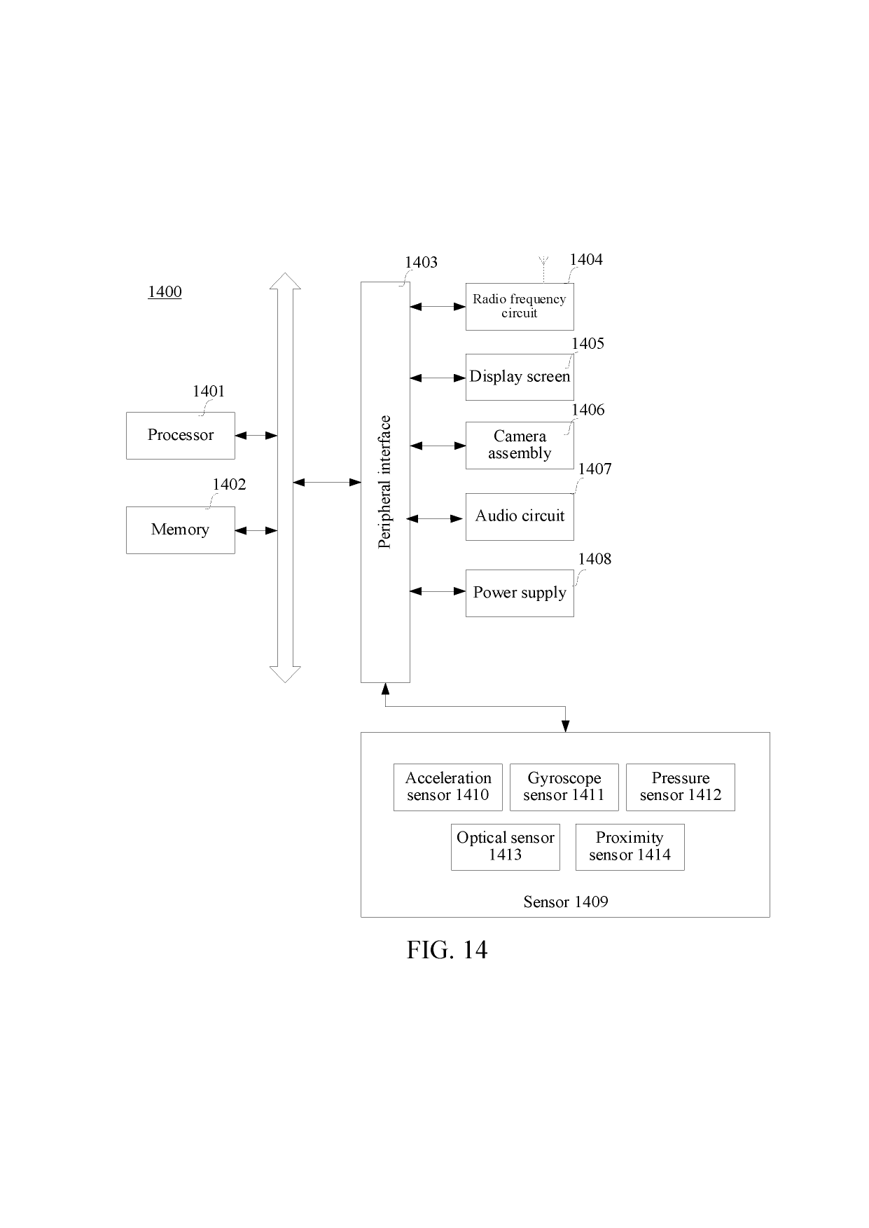

FIG. 14 is a structural block diagram of a computer device 1400 according to an aspect of this disclosure. The computer device 1400 may be a portable mobile terminal, for example, a smartphone, a tablet computer, an MP3 player, an MP4 player, a laptop computer, or a desktop computer. The computer device 1400 may be referred to as other names such as user equipment, a portable terminal, a laptop terminal, or a desktop terminal.

In some aspects, the computer device 1400 includes processing circuitry (e.g., a processor 1401) and a memory 1402.

The processor 1401 may include one or more processing cores, for example, a 4-core processor or an 8-core processor. The processor 1401 may be implemented in at least one hardware form of digital signal processing (DSP), a field-programmable gate array (FPGA), or a programmable logic array (PLA). The processor 1401 may include a main processor and a coprocessor. The main processor may be a processor for processing data in an awake state, and is also referred to as a CPU. The coprocessor may be a low power consumption processor for processing the data in a standby state. In some aspects, the processor 1401 may be integrated with a graphics processing unit (GPU). The GPU may be configured to render and draw content to be displayed on a display screen. In some aspects, the processor 1401 may further include an AI processor. The AI processor may be configured to perform computing operations related to machine learning.

The memory 1402 may include one or more non-transitory computer-readable storage media. The non-transitory computer-readable storage medium may be non-transient. The memory 1402 may further include a high-speed random access memory, and a non-volatile memory, for example, one or more disk storage devices or flash storage devices. In some aspects, the non-transitory computer-readable storage medium in the memory 1402 may be configured to store at least one instruction. The at least one instruction may be configured to be executed by the processor 1401 to implement the model-based prediction method provided in the method aspects of this disclosure.

In some aspects, the computer device 1400 may include a peripheral interface 1403 and at least one peripheral. The processor 1401, the memory 1402, and the peripheral interface 1403 may be connected through a bus or a signal cable. Each peripheral may be connected to the peripheral interface 1403 through a bus, a signal cable, or a circuit board. By way of example, the peripheral may include at least one of a radio frequency (RF) circuit 1404, a display screen 1405, a camera assembly 1406, an audio circuit 1407, or a power supply 1408.

The peripheral interface 1403 may be configured to connect at least one peripheral related to I/O to the processor 1401 and the memory 1402. In some aspects, the processor 1401, the memory 1402, and the peripheral interface 1403 are integrated on the same chip or circuit board. In some other aspects, any one or two of the processor 1401, the memory 1402, and the peripheral interface 1403 may be implemented on an independent chip or circuit board. This is not limited in this aspect.

The RF circuit 1404 may be configured to receive and transmit an RF signal, which is also referred to as an electromagnetic signal. The RF circuit 1404 may communicate with a communication network and other communication devices through the electromagnetic signal. The RF circuit 1404 may convert an electric signal into an electromagnetic signal for transmission, or may convert a received electromagnetic signal into an electric signal. In some aspects, the RF circuit 1404 includes: an antenna system, an RF transceiver, one or more amplifiers, a tuner, an oscillator, a digital signal processor, a codec chip set, a subscriber identity module card, and the like. The RF circuit 1404 may communicate with other terminals through at least one wireless communication protocol. The wireless communication protocol may include: a world wide web, a metropolitan area network, an intranet, generations of mobile communication networks (2G, 3G, 4G, or 5G), a wireless local area network, and/or a WiFi network. In some aspects, the RF circuit 1404 may further include a near field communication (NFC)-related circuit. This is not limited in this disclosure.

The display screen 1405 may be configured to display a user interface (UI). The UI may include graphics, text, icons, videos, or any combination thereof. When the display screen 1405 is a touch display screen, the display screen 1405 may further have a capability of acquiring a touch signal on or above a surface of the display screen 1405. The touch signal may be inputted, as a control signal, into the processor 1401 for processing. In this case, the display screen 1405 may be further configured to provide a virtual button and/or a virtual keyboard, which are/is also referred to as a soft button and/or a soft keyboard. In some aspects, there may be one display screen 1405, disposed on a front panel of the computer device 1400. In some other aspects, there may be at least two display screens 1405 that are respectively disposed on different surfaces of the computer device 1400 or in a folded design. In some other aspects, the display screen 1405 may be a flexible display screen, disposed on a curved surface or a folded surface of the computer device 1400. The display screen 1405 may be even configured as a non-rectangular irregular figure, namely, a special-shaped screen. The display screen 1405 may be manufactured by using materials such as a liquid crystal display (LCD) or an organic light-emitting diode (OLED).

The camera assembly 1406 may be configured to capture images or videos. In some aspects, the camera assembly 1406 includes a front camera and a rear camera. The front camera may be disposed on the front panel of the terminal, and the rear camera may be disposed on the back of the terminal. In some aspects, there are at least two rear cameras, which are respectively any of a main camera, a depth-of-field camera, a wide-angle camera, or a telephoto camera, to achieve background blur through fusion of the main camera and the depth-of-field camera, panoramic photographing and virtual reality (VR) photographing through fusion of the main camera and the wide-angle camera, or other fusion photographing functions. In some aspects, the camera assembly 1406 may further include a flash. The flash may be a single color temperature flash or a double color temperature flash. The double color temperature flash may be a combination of a warm flash and a cold flash, and may be configured to perform light ray compensation at different color temperatures.

The audio circuit 1407 may include a microphone and a speaker. The microphone may be configured to acquire sound waves of users and surroundings, and convert the sound waves into electrical signals and input the signals to the processor 1401 for processing, or input the signals to the RF circuit 1404 to implement voice communication. For the purpose of stereo sound acquisition or noise reduction, there may be a plurality of microphones, respectively disposed at different parts of the computer device 1400. The microphone may be an array microphone or an omnidirectional acquisition microphone. The speaker may be configured to convert the electric signal from the processor 1401 or the RF circuit 1404 into sound waves. The speaker may be a thin-film speaker or a piezoelectric ceramic speaker. When the speaker is a piezoelectric ceramic speaker, the speaker may not only convert an electric signal into sound waves audible to a human being, but also convert an electric signal into sound waves inaudible to the human being for ranging and other purposes. In some aspects, the audio circuit 1407 may further include a headphone jack.

The power supply 1408 is configured to supply power to assemblies in the computer device 1400. The power supply 1408 may be an alternating current, a direct current, a primary battery, or a rechargeable battery. When the power supply 1408 includes a rechargeable battery, and the rechargeable battery may be a wired rechargeable battery or a wireless rechargeable battery. The wired rechargeable battery is a battery charged by using a wired line, and the wireless rechargeable battery is a battery charged by using a wireless coil. The rechargeable battery may further be configured to support a fast charging technology.

In some aspects, the computer device 1400 further includes one or more sensors 1409. The one or more sensors 1409 may include an acceleration sensor 1410, a gyroscope sensor 1411, a pressure sensor 1412, an optical sensor 1413, or a proximity sensor 1414.

The acceleration sensor 1410 may detect acceleration on three coordinate axes of a coordinate system established by the computer device 1400. For example, the acceleration sensor 1410 may be configured to detect components of gravity acceleration on the three coordinate axes. The processor 1401 may control, based on a gravity acceleration signal collected by the acceleration sensor 1410, the display screen 1405 to display the UI in a landscape view or a portrait view. The acceleration sensor 1410 may be further configured to acquire motion data of a game or a user.

The gyroscope sensor 1411 may detect a body direction and a rotation angle of the computer device 1400. The gyroscope sensor 1411 may cooperate with the acceleration sensor 1410 to acquire a 3D action by the user on the computer device 1400. The processor 1401 may implement the following functions according to the data acquired by the gyroscope sensor 1411: motion sensing (such as changing the UI according to a tilt operation of the user), image stabilization at shooting, game control, and inertial navigation.

The pressure sensor 1412 may be disposed on a side frame of the computer device 1400 and/or a layer below the display screen 1405. When the pressure sensor 1412 is disposed on the side frame of the computer device 1400, a holding signal of a user on the computer device 1400 may be detected. The processor 1401 performs left/right hand recognition or a quick operation based on the holding signal acquired by the pressure sensor 1412. When the pressure sensor 1412 is disposed on the layer below the display screen 1405, the processor 1401 controls an operable control on the UI according to a press operation performed by the user on the display screen 1405. The operable control includes at least one of a button control, a scroll bar control, an icon control, or a menu control.

The optical sensor 1413 is configured to acquire ambient light intensity. In an aspect, the processor 1401 may control display brightness of the display screen 1405 based on the ambient light intensity collected by the optical sensor 1413. By way of example, when the ambient light intensity is relatively high, display brightness of the display screen 1405 is increased. When the ambient light intensity is relatively low, the display brightness of the display screen 1405 is decreased. In another aspect, the processor 1401 may further dynamically adjust a camera parameter of the camera assembly 1406 according to the ambient light intensity acquired by the optical sensor 1413.

The proximity sensor 1414, also referred to as a distance sensor, may be disposed on the front panel of the computer device 1400. The proximity sensor 1414 may be configured to acquire a distance between a user and a front surface of the computer device 1400. In an aspect, when the proximity sensor 1414 detects that the distance between the user and the front surface of the computer device 1400 is gradually reduced, the processor 1401 may control the display screen 1405 to switch from a screen-on state to a screen-off state. When the proximity sensor 1414 detects that the distance between the user and the front surface of the computer device 1400 is gradually increased, the processor 1401 may control the display screen 1405 to switch from the screen-off state to the screen-on state.

A person skilled in the art may understand that the structure shown in FIG. 14 constitutes no limitation on the computer device 1400, and the computer device may include more or fewer assemblies than those shown in the figure, or some assemblies may be combined, or a different assembly deployment may be used.

The modules, submodules, and units described in this disclosure may be implemented by processing circuitry (e.g., one or more processors or controllers), software (e.g., computer program instructions stored on a non-transitory computer-readable storage medium and executed by processing circuitry), or a combination thereof. A software module may reside in a non-transitory computer-readable storage medium coupled to processing circuitry. The term “processing circuitry” as used herein may refer to, be part of, or include an application-specific integrated circuit (ASIC), an electronic circuit, a processor (shared, dedicated, or group) and/or memory (shared, dedicated, or group) that executes one or more software or firmware programs, a combinational logic circuit, and/or other suitable components that provide the described functionality.

As used herein, the phrase “at least one of A, B, or C” is intended to include any one of A, B, or C, or any combination of A, B, and/or C, including combinations with multiples of each element. As used herein, the phrase “one of A or B” is intended to include A, B, or both A and B.

This disclosure further provides non-transitory computer-readable storage media. A non-transitory computer-readable storage medium may have at least one instruction, at least one program, a code set, or an instruction set stored therein. The at least one instruction, the at least one program, the code set, or the instruction set may be loaded and executed by processing circuitry to implement the model-based prediction method provided in the foregoing method aspects.

This disclosure provides a computer program product or a computer program, including computer instructions. The computer instructions are stored in a non-transitory computer-readable storage medium. Processing circuitry of the computer device reads the computer instructions from the non-transitory computer-readable storage medium. The processing circuitry executes the computer instructions, to cause the computer device to perform one or more model-based prediction methods described in the foregoing aspects.

The sequence numbers of the foregoing aspects of this disclosure are for description purposes and do not represent the superiority or inferiority of the aspects.

A person of ordinary skill in the art may understand that all or part of the operations of implementing the foregoing aspects may be implemented by hardware, or may be implemented by a program instructing related hardware. The program may be stored in a non-transitory computer-readable storage medium. The foregoing storage medium may be a ROM, a magnetic disk, an optical disc, or the like.

A computer device predicts a first task by using a multi-task model through a first upper-layer network structure among a plurality of upper-layer network structures thereof, to obtain an initial prediction result. Global knowledge information of the multi-task model may be obtained. The global knowledge information represents comprehensive prediction information jointly reflected by at least two tasks. Then, an updated prediction result of the first task may be predicted according to a network layer output of the first upper-layer network structure and the global knowledge information. Then, a difference prompt may be obtained according to a difference between the initial prediction result and the updated prediction result, and the first upper-layer network structure may be guided to correct the initial prediction result by using the difference prompt, to obtain a refined prediction result. In this method, global knowledge information may be introduced and a prediction result may be corrected based on a difference prompt, so that a guiding effect of the global knowledge information may be better used to help improve accuracy of the prediction result and multi-task prediction consistency.

Further, a difference value between the initial prediction result and the updated prediction result of the first task may be calculated, to obtain a first difference value. Then, an embedding operation may be performed on the first difference value, so that the difference prompt is in a target latent space in which a feature embedding vector inputted to a lower-layer network structure is located. The difference prompt constructed in this way may not rely on a manually designed text template, may be more flexible and have a better effect, and can guide a model to correct a prediction result, thereby improving prediction accuracy.

In the process of obtaining the difference prompt, the first difference value is inputted to a first MLP to perform an embedding operation, so as to obtain the difference prompt. The method of mapping a difference to a latent space prompt by using an MLP is simple and convenient in operation, provides an effective way for generating the difference prompt, and further ensures feasibility and high efficiency of a prediction correction process.

When guiding, based on the difference prompt, the first upper-layer network structure to correct the initial prediction result, the difference prompt and the network layer output of the first upper-layer network structure are concatenated, to obtain an intermediate concatenation result. Then, the intermediate concatenation result is inputted to a result layer of the first upper-layer network structure, to finally obtain the refined prediction result of the first task. The process clarifies a specific operation of correcting the prediction result by using the difference prompt, helping improve the accuracy of the prediction result.

Further, a single cycle process is set. When a difference between an i^{th} prediction result and an (i-1)^{th} prediction result is less than a difference threshold (when an initial value of i is two and i is equal to two, the i^{th} prediction result is the refined prediction result of the first task, and the (i-1)^{th} prediction result is the initial prediction result of the first task), the i^{th} prediction result is outputted. If the difference is not less than the difference threshold, an (i-1)^{th} difference prompt is obtained based on a difference between the i^{th} prediction result and the updated prediction result of the first task, and the first upper-layer network structure is guided according to the difference prompt to correct the i^{th} prediction result to obtain an (i+1)^{th} prediction result, i+1 is updated to i, and the cycle process proceeds again. The prediction result is continuously cyclically corrected, a human reasoning process is simulated, and repeated check and correction are performed, which may help improve the reasoning accuracy, so that a final prediction result is more reliable.

When a network branch of each task includes a global knowledge distillation network, a plurality of network layer outputs of the plurality of upper-layer network structures are aggregated by using the first global knowledge distillation network, to obtain the global knowledge information, and the plurality of network layer outputs are in a one-to-one correspondence with the plurality of upper-layer network structures. This manner provides an effective way to obtain the global knowledge information, assists the model in grasping comprehensive information of a plurality of tasks from an overall perspective, and provides more comprehensive guidance for subsequent prediction.

When the global knowledge information is obtained by using the first global knowledge distillation network, if the first global knowledge distillation network includes a second MLP, a possible operation is concatenating the plurality of network layer outputs of the plurality of upper-layer network structures to obtain a concatenation result, and inputting the concatenation result into the second MLP to obtain the global knowledge information. The method has relatively low invasiveness to original upper-layer network structures, and adds a global knowledge distillation network with slight model modification. In addition, the global knowledge information may be generated by using a MLP, thereby realizing simple operation and strong interpretability.

When a network branch of each task includes a global knowledge distillation network, an attention weight of the network layer output of the first upper-layer network structure with respect to the global knowledge information is calculated by using a first global knowledge distillation network to obtain a first reference weight (a reference weight corresponding to the first task). Next, a weighting operation is performed on the global knowledge information by using the first reference weight to obtain first reference experience (representing experience related to the first task in the global knowledge information). Finally, the updated prediction result of the first task is obtained through prediction based on the first reference experience and the network layer output of the first upper-layer network structure. This process utilizes an attention mechanism to obtain experience related to the first task from the global knowledge information, so as to select the global knowledge information, enable the model to focus on key information, and further improve the accuracy of the updated prediction result.

When calculating the attention weight of the network layer output of the first upper-layer network structure with respect to the global knowledge information through the first global knowledge distillation network, if the first global knowledge distillation network includes a third MLP, the network layer output of the first upper-layer network structure and the global knowledge information are inputted into the third MLP to obtain the first reference weight, and a last network layer of the third MLP is a softmax layer. By adopting the third MLP to calculate the attention weight, this manner is simple in operation, provides an effective means for obtaining the global knowledge information related to the first task, and helps improve the accuracy of the updated prediction result.

After the first reference experience is obtained, if the first global knowledge distillation network includes a fourth MLP, the first reference experience and the network layer output of the first upper-layer network structure are inputted into the fourth MLP, and the updated prediction result of the first task is obtained through prediction. This method adopts the fourth MLP for prediction again, the model structure is simple, and a feasible manner is provided for predicting an updated result based on the global knowledge information and the network layer output, thereby helping improve prediction efficiency and accuracy.

Further, a plurality of prediction result means (each prediction result mean is a mean of a plurality of refined prediction results obtained by performing one task on a plurality of test samples) in one-to-one correspondence with a plurality of tasks are obtained. Test samples in which the refined prediction result of each task is greater than the prediction result mean corresponding to the task among the plurality of test samples are counted, to obtain a first quantity. Meanwhile, test samples in which the refined prediction result of each task is less than the prediction result mean corresponding to the task among the plurality of test samples are counted, to obtain a second quantity. Finally, a sum of the first quantity and the second quantity is divided by a total quantity (a quantity of the plurality of test samples) to obtain a task consistency indicator of the plurality of tasks. The indicator may measure the directional consistency of prediction results of a plurality of tasks. A larger value indicates that the overall prediction results of the plurality of tasks are relatively accurate, which provides an effective reference for evaluating a multi-task prediction effect of a model.

The technical features of the foregoing aspects may be combined in various manners. For the sake of brevity, not all possible combinations of the technical features in the foregoing aspects have been described. However, any combination of these technical features is to be considered within the scope of this disclosure, provided that no contradiction arises.

The foregoing aspects describe several implementations of this disclosure and the descriptions are not to be understood as a limitation to the scope of this disclosure. For those of ordinary skill in the art, several transformations and improvements may further be made without departing from the idea of this disclosure. These transformations and improvements fall within the scope of this disclosure.

What is claimed is:

1. A model-based prediction method, the method comprising:
generating an initial prediction result of a first task through a first upper-layer network structure of a plurality of upper-layer network structures of a multi-task model based on a lower-layer output of a lower-layer network structure of the multi-task model;
generating, by processing circuitry, global knowledge information based on an output of the first upper-layer network structure and an output of each of one or more other upper-layer network structures of the plurality of upper-layer network structures;
generating an updated prediction result of the first task based on a network layer output of the first upper-layer network structure and the global knowledge information;
generating a difference prompt based on a difference between the initial prediction result of the first task and the updated prediction result of the first task; and
generating, by the processing circuitry, a refined prediction result of the first task through the first upper-layer network structure based on the difference prompt and the initial prediction result of the first task.

2. The method according to claim 1, wherein
the method further includes generating the lower-layer output through the lower-layer network structure of the multi-task model based on an audience feature of a target audience and a content feature of a piece of content;
the plurality of upper-layer network structures corresponds to predicting a plurality of respective reactions of the target audience to the piece of content; and
the piece of content to the target audience is presented based on a ranking that is determined based on the refined prediction result of the first task.

3. The method according to claim 1, wherein the generating the difference prompt comprises:
calculating a first difference value between the initial prediction result of the first task and the updated prediction result of the first task; and
performing an embedding operation on the first difference value to obtain the difference prompt.

4. The method according to claim 3, wherein
the difference prompt is in a target latent space; and
the target latent space is a vector space in which a feature embedding vector to-be-inputted into the lower-layer network structure is.

5. The method according to claim 3, wherein
the embedding operation is performed through a first multi-layer perceptron (MLP) based on the first difference value as input.

6. The method according to claim 1, wherein the generating the refined prediction result of the first task comprises:
concatenating the difference prompt and the network layer output of the first upper-layer network structure to obtain an intermediate concatenation result; and
inputting the intermediate concatenation result into a result layer of the first upper-layer network structure to obtain the refined prediction result of the first task.

7. The method according to claim 1, further comprising:
outputting, an i^{th} prediction result as the refined prediction result of the first task when a difference between the i^{th} prediction result and an (i-1)^{th} prediction result is less than a difference threshold in a current evaluation cycle, i being an integer with an initial value of two; and
when the difference between the i^{th} prediction result and the (i-1)^{th} prediction result is not less than the difference threshold in the current evaluation cycle,
generating an (i-1)^{th} difference prompt based on a difference between the i^{th} prediction result and the (i-1)^{th} prediction result;
generating an (i+1)^{th} prediction result through the first upper-layer network structure based on the (i-1)^{th} difference prompt and the i^{th} prediction result,
updating i+1 as i, and
proceeding to a next evaluation cycle.

8. The method according to claim 1, wherein
the multi-task model includes a plurality of network branches, each network branch of the plurality of network branches corresponding to a respective task of a plurality of tasks and including a respective one of the plurality of upper-layer network structures and a respective global knowledge distillation network, the plurality of tasks including the first task and at least one additional task; and
the generating the global knowledge information includes:
aggregating, by using a first global knowledge distillation network in the network branch of the first task, the output of the first upper-layer network structure in the network branch of the first task and the output of each of the one or more other upper-layer network structures of the plurality of upper-layer network structures in the network branch of each of the at least one additional task.

9. The method according to claim 8, wherein
the first global knowledge distillation network includes a second multi-layer perceptron (MLP); and
the aggregating the output of the first upper-layer network structure and the output of each of the one or more other upper-layer network structures includes:
concatenating the output of the first upper-layer network structure and the output of each of the one or more other upper-layer network structures to obtain a concatenation result; and
inputting the concatenation result into the second MLP to obtain the global knowledge information.

10. The method according to claim 1, wherein
the multi-task model includes a plurality of network branches, each network branch of the plurality of network branches corresponding to a respective task of a plurality of tasks and including a respective one of the plurality of upper-layer network structures and a respective global knowledge distillation network, the plurality of tasks including the first task and at least one additional task; and
the generating the updated prediction result of the first task includes:
calculating, by using a first global knowledge distillation network in the network branch of the first task, an attention weight of the network layer output of the first upper-layer network structure with respect to the global knowledge information to obtain a first reference weight corresponding to the first task;
performing a weighting operation on the global knowledge information by using the first reference weight to obtain first reference knowledge information representing knowledge information related to the first task in the global knowledge information; and
obtaining the updated prediction result of the first task based on the first reference knowledge information and the network layer output of the first upper-layer network structure.

11. The method according to claim 10, wherein
the first global knowledge distillation network includes a third multi-layer perceptron (MLP); and
the calculating the attention weight of the network layer output of the first upper-layer network structure includes:
inputting the network layer output of the first upper-layer network structure and the global knowledge information into the third MLP to obtain the first reference weight, a last network layer of the third MLP being a softmax layer.

12. The method according to claim 10, wherein
the first global knowledge distillation network includes a fourth multi-layer perceptron (MLP); and
the generating the updated prediction result includes:
inputting the first reference knowledge information and the network layer output of the first upper-layer network structure into the fourth MLP; and
obtaining the updated prediction result of the first task from the first global knowledge distillation network.

13. The method according to claim 1, further comprising:
obtaining a plurality of prediction result means in one-to-one correspondence with a plurality of tasks, each prediction result mean being a mean of a plurality of refined prediction results obtained by performing one task on a plurality of test samples;
counting test samples in which the refined prediction result of each task is greater than the prediction result mean corresponding to the task among the plurality of test samples, to obtain a first quantity;
counting test samples in which the refined prediction result of each task is less than the prediction result mean corresponding to the task among the plurality of test samples, to obtain a second quantity; and
dividing a sum of the first quantity and the second quantity by a total quantity to obtain a task consistency indicator of the plurality of tasks, the total quantity being a quantity of the plurality of test samples.

14. A model-based prediction apparatus, comprising:
processing circuitry configured to:
generate an initial prediction result of a first task through a first upper-layer network structure of a plurality of upper-layer network structures of a multi-task model based on a lower-layer output of a lower-layer network structure of the multi-task model;
generate global knowledge information based on an output of the first upper-layer network structure and an output of each of one or more other upper-layer network structures of the plurality of upper-layer network structures;
generate an updated prediction result of the first task based on a network layer output of the first upper-layer network structure and the global knowledge information;
generate a difference prompt based on a difference between the initial prediction result of the first task and the updated prediction result of the first task; and
generate a refined prediction result of the first task through the first upper-layer network structure based on the difference prompt and the initial prediction result of the first task.

15. The apparatus according to claim 14, wherein
the processing circuitry is configured to generate the lower-layer output through the lower-layer network structure of the multi-task model based on an audience feature of a target audience and a content feature of a piece of content;
the plurality of upper-layer network structures corresponds to predicting a plurality of respective reactions of the target audience to the piece of content; and
the piece of content to the target audience is presented based on a ranking that is determined based on the refined prediction result of the first task.

16. The apparatus according to claim 14, wherein the processing circuitry is configured to:
calculate a first difference value between the initial prediction result of the first task and the updated prediction result of the first task; and
perform an embedding operation on the first difference value to obtain the difference prompt.

17. The apparatus according to claim 14, wherein the processing circuitry is configured to:
concatenate the difference prompt and the network layer output of the first upper-layer network structure to obtain an intermediate concatenation result; and
input the intermediate concatenation result into a result layer of the first upper-layer network structure to obtain the refined prediction result of the first task.

18. The apparatus according to claim 14, wherein the processing circuitry is configured to:
output, an i^{th} prediction result as the refined prediction result of the first task when a difference between the i^{th} prediction result and an (i-1)^{th} prediction result is less than a difference threshold in a current evaluation cycle, i being an integer with an initial value of two; and
when the difference between the i^{th} prediction result and the (i-1)^{th} prediction result is not less than the difference threshold in the current evaluation cycle,
generate an (i-1)^{th} difference prompt based on a difference between the i^{th} prediction result and the (i-1)^{th} prediction result;
generate an (i+1)^{th} prediction result through the first upper-layer network structure based on the (i-1)^{th} difference prompt and the i^{th} prediction result,
update i+1 as i, and
proceed to a next evaluation cycle.

19. The apparatus according to claim 14, wherein
the multi-task model includes a plurality of network branches, each network branch of the plurality of network branches corresponding to a respective task of a plurality of tasks and including a respective one of the plurality of upper-layer network structures and a respective global knowledge distillation network, the plurality of tasks including the first task and at least one additional task; and
the processing circuitry is configured to:
aggregate, by using a first global knowledge distillation network in the network branch of the first task, the output of the first upper-layer network structure in the network branch of the first task and the output of each of the one or more other upper-layer network structures of the plurality of upper-layer network structures in the network branch of each of the at least one additional task.

20. A non-transitory computer-readable storage medium storing instructions, which when executed by a processor, cause the processor to perform a model-based prediction method, the method comprising:
generating an initial prediction result of a first task through a first upper-layer network structure of a plurality of upper-layer network structures of a multi-task model based on a lower-layer output of a lower-layer network structure of the multi-task model;
generating global knowledge information based on an output of the first upper-layer network structure and an output of each of one or more other upper-layer network structures of the plurality of upper-layer network structures;
generating an updated prediction result of the first task based on a network layer output of the first upper-layer network structure and the global knowledge information;
generating a difference prompt based on a difference between the initial prediction result of the first task and the updated prediction result of the first task; and
generating a refined prediction result of the first task through the first upper-layer network structure based on the difference prompt and the initial prediction result of the first task.
